(19) United States
(12) Patent Application Publication
(10) Pub. No.: US 2013/0090947 A1
(43) Pub. Date: Apr. 11, 2013

(54) PHARMACEUTICAL DATABASE AND OPERATIONAL METHOD

(71) Applicant: David Lee Nockley, Plains, PA (US)

(72) Inventor: David Lee Nockley, Plains, PA (US)

(73) Assignee: PAN SOLUTIONS, LLC, Hanover Township, PA (US)

(21) Appl. No.: 13/524,543

(22) Filed: Jun. 15, 2012

Related U.S. Application Data
(60) Provisional application No. 61/457,839, filed on Jun. 16, 2011.

(51) Int. Cl. G06F 19/00

(52) U.S. Cl. CPC G06F 19/322
USPC 705/3

(57) ABSTRACT

A system and method for prescribing, filling and dispensing a prescription with reference to a universal prescription database is provided. Every patient is assigned a unique patient identifier in the universal prescription database, and preferably, every prescription dispensed to a patient is recorded in the database regardless of whether the patient uses a universally accepted insurance card, and regardless of which pharmacy is used by the patient for previous or current prescriptions. Drug allergies, negative drug-disease state interactions, negative drug-drug interactions, duplicate therapies, early refills (overuse of a medication), and other potential negative problems not previously identifiable by pharmacists are identified and preferably rated according to severity.

The present application claims the benefit under 35 U.S.C. §119(e) of U.S. Provisional Application No. 61/457,839, filed Jun. 16, 2011, the entire content of which is hereby incorporated by reference.

### BACKGROUND OF THE INVENTION

1. Field of the Invention

The present invention relates to systems and methods for prescribing, filling and dispensing prescriptions. More particularly, the present invention relates to a universal database utilized by licensed prescribers and licensed pharmacists to assist in determining whether a prescription should be written and subsequently filled and dispensed based on a comprehensive search of drug allergies, negative drug-disease state interactions, negative drug-drug interactions, duplicate therapies, early refills (overuse of a medication), and other potential negative problems.

2. Description of the Related Art

Each year, over 4 billion prescriptions are filled and dispensed from pharmacies in the United States. Prescriptions are filled and dispensed in various ways, such as traditional retail chain pharmacies, independent pharmacies, and mail order pharmacies among other methods. Unfortunately, with the increase of prescriptions being dispensed there is also an increase in adverse effects due to drug allergies, negative drug-disease state interactions, negative drug-drug interactions, duplicate therapies, early refills (overuse of a medication), and other potential negative problems. Additionally, patients often use multiple physicians to obtain prescriptions as well as utilizing multiple pharmacies at which to have the prescriptions filled. Unless a person uses the same pharmacy for every prescription they have filled, stay within the same retail chain, or uses the same universally accepted insurance card for every prescription filled, there is currently no way for prescribers and pharmacists to know every medication that has been prescribed for a specific patient by another prescriber and/or dispensed by another pharmacist. Ultimately, this results in preventable medication errors. These errors subsequently result in increased healthcare costs. Unnecessary testing, invisible hospital costs and redundant insurance claims add to these preventable, unwanted costs. Accordingly, there is a need to reduce the frequency of these preventable errors, thus decreasing the negative impact these errors have on both patients and healthcare in general.

Typically, when a prescriber writes a prescription, he or she does so with the assumption that the patient has provided a complete medical history to them. It is assumed that history includes a complete list of all medications the patient is currently taking as well as what prescriber(s) has issued the prescription(s). When the prescription is presented to a pharmacist, the pharmacist typically checks local (in house) prescription records to determine if the prescription should be dispensed. The pharmacist checks for drug allergies, negative drug-disease state interactions, negative drug-drug interactions, duplicate therapies, early refills (overuse of a medication), and other potential negative problems with other drugs the patient may be taking. Unfortunately, the pharmacist's ability to check for problems is limited by the lack of comprehensiveness of the prescription records that are available to him or her. Individual pharmacies may keep local (in house) records. Retail pharmacies may keep records across the entire retail chain. Pharmacies may have access to additional records via a patient's prescription insurance company. However, each of the above described systems has limitations, and as a result, pharmacists must determine whether to fill a prescription based on incomplete information.

In other words, there currently exists no uniform system or database for prescribers and pharmacists in every sector, including retail, hospital, mail order, and so on, to utilize in their attempt to perform a comprehensive check of a patient's prescription records prior to prescribing and dispensing medication. This dilemma exists regardless of whether the patient uses a universal insurance card or no insurance card at all (e.g. paying “CASH”). Ideally, a medication search should provide information relevant only to the prescription that is being prescribed and dispensed, maintaining the confidentiality of a patient's complete medication record while at the same time adhering to The Health Insurance Portability and Accountability Act of 1996 (HIPAA) Privacy and Security Rules and Regulations. This information could then be utilized by the prescriber and pharmacist to determine the appropriateness of prescribing and dispensing a medication(s). The availability of such a system to all prescribers and its implementation into all pharmacies would provide a universal database for all prescribers and pharmacists to utilize, allowing them to make the appropriate decision in regard to prescribing, filling and dispensing a specific prescription.

Pharmacists currently utilize various checks and balances to determine drug allergies, negative drug-disease state interactions, negative drug-drug interactions, duplicate therapies, early refills (overuse of a medication), and other potential negative problems, the major causes of adverse events as a result of dispensing medications. Initially, the pharmacist may utilize retained knowledge. Unfortunately, with the number of medications commercially available today as well as the countless number of interactions, it is virtually impossible for anyone to have that amount of information committed to memory. Thus, an in-house computer system is required and utilized as a secondary method. This system utilizes a pre-installed and routinely updated database of such interactions which automatically identifies potential problems. This system would work great if, and only if, the individual utilized only one pharmacy or pharmacy chain. Unfortunately, this seldom happens. A third method of tracking patient medications occurs when the pharmacy's computer system transmits an electronic claim to the patient's insurance carrier, assuming the patient has a universally accepted insurance card. Insurance companies use a common database that records every prescription filled using only their card regardless of the pharmacy used. Using this stored information, an evaluation is done to determine if pharmacist intervention is required. These results are relayed to the pharmacist for review to determine the course of action.

While the conventional systems and methods discussed above have been somewhat successful, there remain disadvantages and gaps in information that may lead to the dispensing of medications that should not be dispensed. Current systems are only effective if: (1) the person attempting to have the prescription filled uses one exclusive pharmacy or pharmacy chain, whether using prescription insurance or not, or (2) the person attempting to have the prescription filled presents the same, valid prescription insurance card regardless of the pharmacy used and that the insurance card is accepted by all pharmacies. Rarely does this occur.

The ability of pharmacists to successfully identify problems using currently available systems becomes compromised when patients use multiple pharmacies and/or do not use the same universally accepted prescription insurance card each time a prescription is filled. Therefore, a new system is necessary for use by prescribers and pharmacists to provide a common database to be utilized each time a prescription is prescribed and filled regardless of where it is filled or whether the patient chooses to utilize a universally accepted prescription insurance card or not. Such a system would reduce preventable medication errors caused by incomplete information being available to the prescriber and dispensing pharmacist. Such a system would provide peace of mind for prescribers and pharmacists since potentially all problems that may exist with a particular prescription fill could be checked by the prescriber and pharmacist with the click of a button. Such a system would provide advantages to prescribers as well as pharmacists to permit them to evaluate a patient's prescription records for drug allergies, negative drug-disease state interactions, negative drug-drug interactions, duplicate therapies, early refills (overuse of a medication), and other potential negative problems prior to prescribing, filling and dispensing prescriptions as if every pharmacy were part of one universal pharmacy chain.

### SUMMARY OF THE INVENTION

Embodiments of the present invention overcome the disadvantages of presently available systems and databases described above and provide several advantages as will be described below.

According to an exemplary embodiment of the present invention, a universal prescription database is provided. The database includes a storage medium storing a plurality of patient records and prescription records. The patient records each include at least a unique patient identifier. The prescription records each comprise of at least a patient identifier, a drug identifier, a strength, a quantity, and a prescription fill date. The database further includes a communications interface for receiving database requests from remote terminals, and for sending database responses to remote terminals. The universal prescription database is programmed to receive a database request via the communications interface, the database request including at least a new prescription record. The database compares the new prescription record with existing prescription records associated with the same unique patient identifier, and sends a response to remote terminals via the communications interface. The response is based on the comparison of the new prescription record with existing prescription records associated with the same unique patient identifier.

According to another exemplary embodiment of the present invention, a method of filling a prescription using a universal prescription database is provided. The method includes storing a plurality of patient records, prescriber records, prescription records, pharmacy records and dispenser's records in a storage medium of the universal prescription database. The patient records each include a number of unique patient identifiers (e.g. patient first name, last name, date of birth, social security number, etc.). The prescription records each comprise of a number of unique patient identifiers, a drug identifier [National Drug Code (NDC #)], drug strength, a dispensed quantity, a day supply, instructions for use, prescription written date, and a prescription fill date. The prescription record will also comprise of a series of prescriber's identifiers (e.g. prescriber's first name, last name, DEA number, NPI number, state license number(s), office phone address, office phone number, office facsimile number, etc.). The prescription record will further comprise of a series of dispenser's identifiers (e.g. pharmacy name and store number, address, phone number, facsimile number, dispensing pharmacist first name, last name, state license number and NPI number, etc.). The method further includes receiving a database request from remote terminals via a secure communications interface of the universal prescription database. The database request comprises of a new prescription or a refill of an existing prescription. The method includes comparing the transmitted prescription record with existing prescription records associated with the same unique patient identifier and preparing a response based on the comparison. The method further includes sending the response to remote terminals via the secure communications interface. The responses include, but are not limited to, drug allergies, negative drug-disease state interactions, negative drug-drug interactions, duplicate therapies, early refills (overuse of a medication), and other potential negative problems.

The universal prescription database is programmed to include a secure communications interface for receiving database requests from remote terminals, and for sending database responses to remote terminals. The database compares the new prescription record with existing prescriptions records associated with the same unique patient identifiers, runs a check based on specific drug identifiers and sends responses to the remote terminals via the secure communications interface. The response is generated based on the comparison of the new prescription record with the existing prescription records associated with the same unique patient and drug identifiers.

While the system previously described explains its use at the pharmacist level, an abbreviated model of the system could be implemented at the prescriber level as well. This system will utilize the same concepts and theories. Prior to prescribing a medication, a prescriber will have the ability to access the same database through an equally secure terminal. The prescriber will securely log into the system, enter the unique patient identifier (e.g. first name, last name, date of birth, social security number) and the prescription information (e.g. drug name, drug strength, quantity, instructions for use, day supply, and so on). The universal prescription database will receive a request from this remote terminal via a secure communication interface. The method includes comparing the transmitted prescription record with existing prescription records associated with the same unique patient identifiers of those prescriptions previously filled and dispensed. A response is then prepared and transmitted back to the remote terminal based on the comparison. The method further includes sending the response to the remote terminal via the secure communications interface. The responses include, but are not limited to, drug allergies, negative drug-disease state interactions, negative drug-drug interactions, duplicate therapies, early refills (overuse of a medication), and other potential negative problems. Upon review, the prescriber could then determine if the prescription should be written for the patient. The universal prescription database, however, preferably does not store prescriber's requests. Only prescriptions dispensed are saved and utilized for use within the system.

One important function of the present invention is the system's ability to produce reports. These reports include, but are not limited to, those particular to patients, prescribers and dispensers. Upon a request from the appropriate entity, the system will provide the ability to evaluate a specific patient's frequency of filling specific prescriptions (e.g. numerous controlled medications). Further, the system will provide the ability to evaluate a specific prescriber's prescribing habits (e.g. unordinary amount of prescribing controlled substances). Another function of the reporting capability of the system is directed towards pharmacists. When the system runs a check on a specific prescription record and an error is returned to the pharmacist for review (e.g. drug allergy, negative drug-disease state interaction, negative drug-drug interaction, duplicate therapy, early refill), the pharmacist has the ability to 1). Choose not to fill the prescription, 2). Override the error and proceed to fill, and 3). View the payment information of the previous prescription that resulted in the problem. If the pharmacist chooses to override the error, the system will capture the information associated with the person who overrode the error. That information will preferably include the pharmacist's first name, last name, National Provider Identifier (NPI) number and state license number. This information could be produced via a report in the event it is required to identify the person who overrode an identified problem via the present system.

### BRIEF DESCRIPTION OF THE DRAWING FIGURES

These and other features and advantages of the present invention will become more apparent from the detailed description of exemplary embodiments with reference to the attached drawings in which:

FIG. 1 is a system diagram of a conventional system for filling prescriptions;

FIG. 2 is a flowchart illustrating a conventional system for filling prescriptions in which a patient does NOT use a universally accepted insurance card;

FIG. 3 is a flowchart illustrating another conventional system for filling prescriptions in which a patient DOES use a universally accepted insurance card;

FIG. 4 is a system diagram for a system for filling prescriptions using a universal prescription database according to an exemplary embodiment of the present invention;

FIGS. 5A and 5B are a flowchart illustrating a method of filling prescriptions using a universal prescription database according to an exemplary embodiment of the present invention;

FIG. 6 is a system diagram illustrating communication interfaces between components of a system according to an exemplary embodiment of the present invention;

FIG. 7 is a system diagram illustrating the flow of data from a remote location (e.g. pharmacy or prescriber) through the series of secure communication interfaces back to the remote location (e.g. pharmacy or prescriber);

FIG. 8 is a flowchart illustrating a method of a prescriber utilizing the present invention to check for any problems in prescribing a specific prescription before issuing the prescription to the patient.

FIG. 9 is a sample screen shot illustrating a response returned to a remote terminal from the universal prescription database identifying a “DRUG ALLERGY” problem and the options available to the pharmacist;

FIG. 10 is a sample screen shot illustrating the data stored by the universal prescription database for reporting purposes when a pharmacist chooses the “DELETE ALLERGY” option;

FIG. 11 is a sample screen shot illustrating the data stored by the universal prescription database for reporting purposes when a pharmacist chooses the “PHARMACIST OVERRIDE” option to override a drug allergy;

FIG. 12 is a sample screen shot illustrating a response returned to a remote terminal from the universal prescription database identifying a “DRUG-DISEASE STATE” interaction and the options available to the pharmacist;

FIG. 13 is a sample screen shot illustrating the data stored by the universal prescription database for reporting purposes when a pharmacist chooses the “PHARMACIST OVERRIDE” option to override a drug-disease state interaction;

FIG. 14 is a sample screen shot illustrating a response returned to a remote terminal from the universal prescription database identifying a “DRUG-DRUG INTERACTION” problem and the options available to the pharmacist;

FIG. 15 is a sample screen shot illustrating a response returned to a remote terminal from the universal prescription database when a pharmacist chooses the “PAYMENT INFORMATION”;

FIG. 16 is a sample screen shot illustrating the data stored by the universal prescription database for reporting purposes when a pharmacist chooses the “PHARMACIST OVERRIDE” option to override a drug-drug interaction;

FIG. 17 is a sample screen shot illustrating a response returned to a remote terminal from the universal prescription database identifying a “DUPLICATE THERAPY” problem and the options available to the pharmacist;

FIG. 18 is a sample screen shot illustrating a response returned to a remote terminal from the universal prescription database when a pharmacist choose the “PAYMENT INFORMATION” option;

FIG. 19 is a sample screen shot illustrating the data stored by the universal prescription database for reporting purposes when a pharmacist chooses the “PHARMACIST OVERRIDE” option to override a duplicate therapy;

FIG. 20 is a sample screen shot illustrating a response returned to a remote terminal from the universal prescription database illustrating an “EARLY REFILL” problem and the options available to the pharmacist;

FIG. 21 is a sample screen shot illustrating a response returned to a remote terminal from the universal prescription database when a pharmacist chooses the “PAYMENT INFORMATION” option;

FIG. 22 is a sample screen shot illustrating the data stored by the universal prescription database for reporting purposes when a pharmacist chooses the “PHARMACIST OVERRIDE” option to override an early refill;

FIG. 23 is a sample screen shot illustrating the response returned to a remote pharmacy terminal from the universal prescription database indicating that a complete search was performed, how many errors were overridden, and what those error were;

Throughout the drawings, like reference numerals will be understood to refer to like features and structures.

### DETAILED DESCRIPTION OF EXEMPLARY EMBODIMENTS

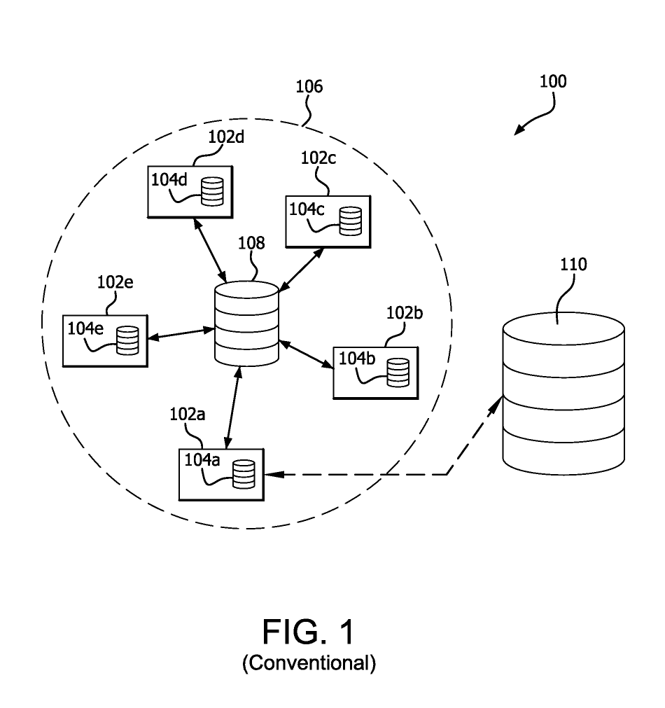

Referring now to FIG. 1, a conventional system 100 for filling prescriptions will be described. As depicted, an individual pharmacy 102a has a local database 104a for storing prescription records for customers. For simplicity of illustration, pharmacy 102a is described herein as a retail pharmacy that is part of a retail chain 106. However, as will be appreciated by those of ordinary skill in the art, the pharmacy 102a description below could also reflect a similar system of mail order pharmacies, hospital pharmacies, independent pharmacies, and so on with very minor modifications. When customers attempt to fill prescriptions at the pharmacy 102a, the pharmacist can check a local database 104a to determine if the prescription should be filled. The database 104a stores records of prior prescriptions filled at the pharmacy 102a by the customer. The local database 104a, however, is limited to records of prescriptions filled at the local pharmacy 102a, and accordingly cannot inform the pharmacist of potential problems due to prescriptions filled elsewhere.

Pharmacy 102a is part of a retail chain 106 that includes other member pharmacies 102b, 102c, 102d, 102e. Each of the other member pharmacies 102b-102e likely have their own local databases 104b, 104c, 104d, 104e for storing records of prescriptions filled at the other member pharmacies, respectively. The retail chain 106 also includes a central database 108 that is accessible from each of the retail chain 106 member pharmacies. The central database 108 is better than the local database, because it contains records of prescriptions filled by a particular customer at any of the retail chain member pharmacies 102a-102e. However, this is still incomplete, as it does not account for prescriptions filled by the customer at a different pharmacy that is not connected to central database 108.

If the customer filling a prescription at pharmacy 102a is using a universal insurance card, than a third database 110 may be accessed. The insurance company database 110 is routinely checked when a customer presents a universal insurance card in order to submit a claim. The insurance company database 110 includes records of prescriptions filled anywhere, as long as an insurance claim was submitted in connection with the prescription. Accordingly, a pharmacist at pharmacy 102a may have access to information via insurance company database 110 that was not available in local database 104a, or retail chain central database 108. Unfortunately, even this scenario leaves gaps in the information available to the pharmacist, since none of the databases discussed above account for prescriptions filled outside the retail chain 106, and without presenting the insurance card of the particular insurance company associated with insurance company database 110. Once a prescription is presented at pharmacy 102a, the local database 104a, the retail chain central database 108, and optionally the insurance company database 110 (if a universal insurance card was presented) are all updated to record a record of the prescription.

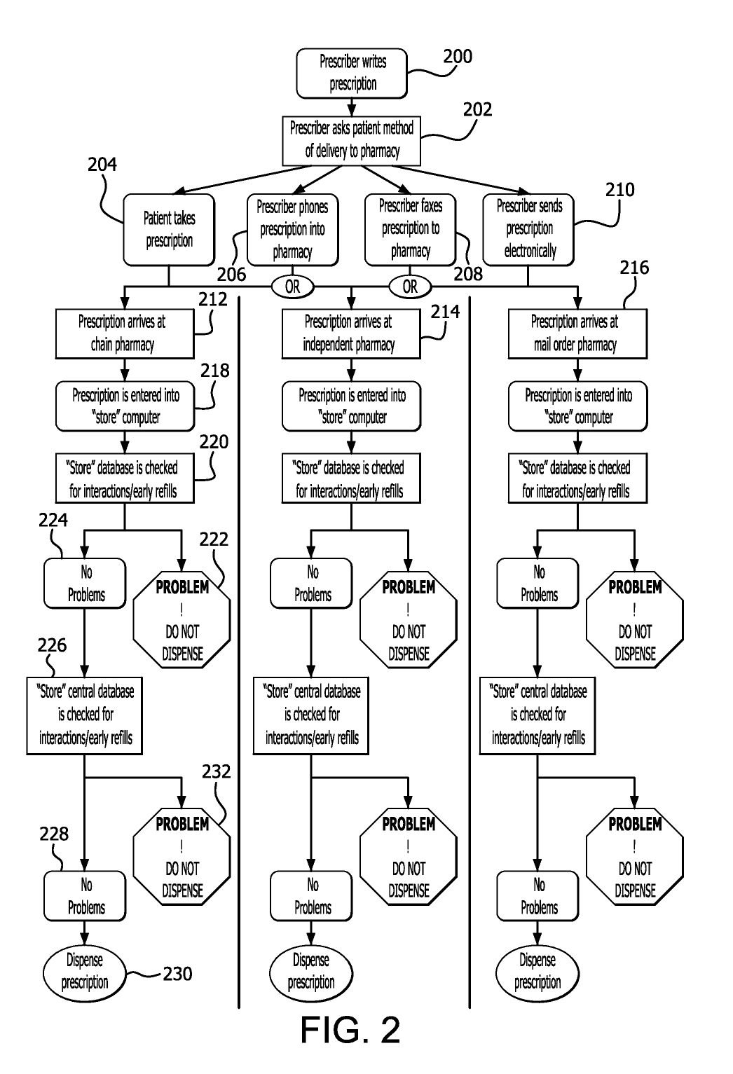

A conventional method of filling a prescription without using a universal prescription card will now be described in connection with FIG. 2. At step 200 a provider writes a prescription, and at step 202 the provider determines how the patient prefers to fill the prescription. The provider may hand a written prescription to the patient at step 204, call the patient's preferred pharmacy with the prescription at step 206, fax the prescription to the patient's pharmacy at step 208, or electronically send the prescription to the pharmacy at step 210. Regardless of the method of transmittal, the prescription next arrives at a pharmacy that may be of several types. If the pharmacy is a traditional retail chain pharmacy, the method continues at step 212 along the left-most column of FIG. 2. If the pharmacy is an independent pharmacy the method continues at step 214 along the middle column of FIG. 2. Finally, if the pharmacy is a mail order pharmacy, the method continues at step 216 along the right-most column of FIG. 2. Of course, those of ordinary skill in the art will appreciate that additional types of pharmacies could be included in additional columns, but are omitted for clarity and brevity.

At a retail chain pharmacy, the prescription is entered into the local store computer at step 218. The store database 104a is checked at step 220 to determine if there are any drug allergies, negative drug-disease state interactions, negative drug-drug interactions, duplicate therapies, early refills (overuse of a medication), and other potential negative problems. If there are any problems identified from the search of local database 104a, an alert is issued and the prescription is not filled at step 222. The local database 104a may be updated to reflect the prescription that was attempted to be filled and the problem that was identified. If however, there are no problems identified, the method continues to step 224. At step 226, the retail chain central database 108 is checked. If there are no problems identified in the records of central database 108, at step 228, then the prescription is filled at step 230. If on the other hand the central database 108 records do identify a problem, than an alert is issued and the prescription is not filled, at step 232.

The method proceeds similarly if the pharmacy is an independent pharmacy, as shown in the middle column of FIG. 2, or a mail order pharmacy, as shown in the right-most column of FIG. 2. Since the method proceeds similarly for independent and mail order pharmacies, a description of the individual steps will not be repeated here. Importantly however, the three columns shown in FIG. 2 do not interact. In other words, problems with drug allergies, negative drug-disease state interactions, negative drug-drug interactions, duplicate therapies, early refills (overuse of a medication), and other potential negative problems could occur and remain undetected if a patient merely uses a first pharmacy, such as a retail pharmacy in the left-most column of FIG. 2 for one prescription, and a different pharmacy such as a mail order (right-most column) or independent pharmacy (middle column) for another prescription.

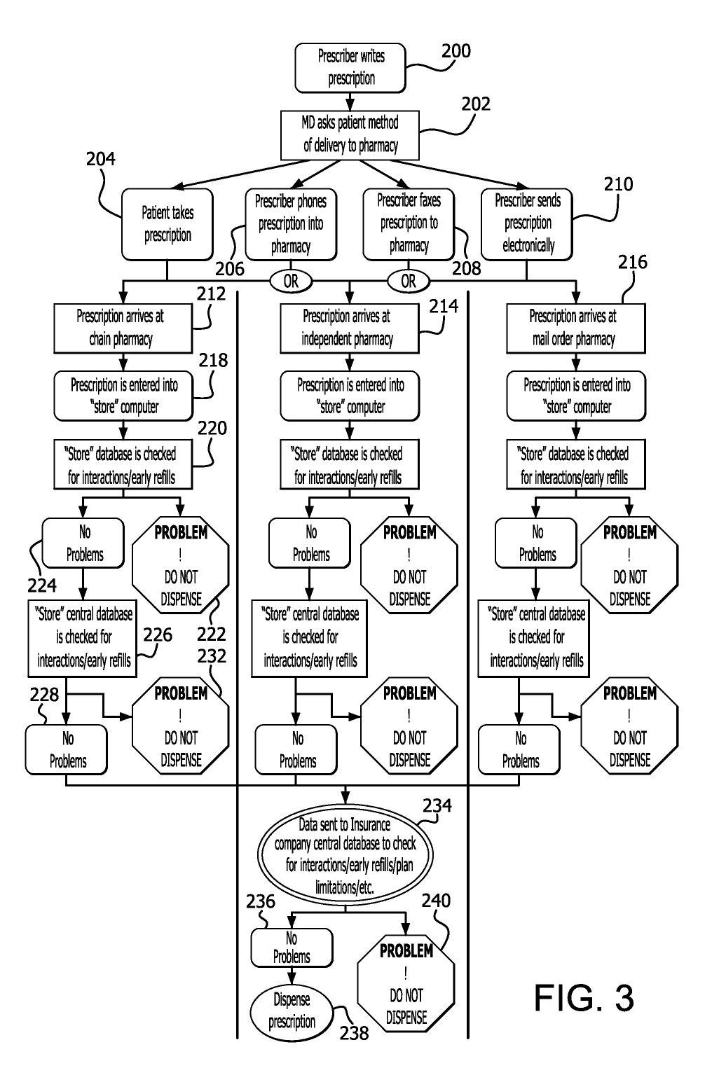

The situation described above is somewhat improved if a patient uses a universal insurance card, although important disadvantages remain, as will be described in connection with FIG. 3. The first portion of the process, from a prescriber writing a prescription (step 200) through the pharmacy central database being checked (steps 226, 228, 232) are substantially the same as described in connection with FIG. 2, and so a detailed description thereof need not be repeated. However, the method includes additional steps if no problems with the prescription are identified at step 228. At step 234, the pharmacy transmits data relating to the prescription to be filled to an insurance company central database 110 to check for potential drug interactions, early refills, insurance plan limitations, and so on. If no problems are identified, at step 236, then the prescription may be dispensed, at step 238. If, however, the records of the central insurance company database 110 indicate a problem, at step 240, then a decision may be made to not dispense.

As shown, the central insurance company database 110 provides the advantage of receiving information from, and providing information to pharmacies from each of the three columns shown in FIG. 3. In other words, the central insurance company database 110 overcomes some of the limitations illustrated in FIG. 2, where a pharmacy in one column does not have access to information stored in a different database only accessible to a different pharmacy in a different column. Unfortunately, the system and method described in connection with FIG. 3 still provides only incomplete information to pharmacists and only works when the patient always uses the same universal insurance card.

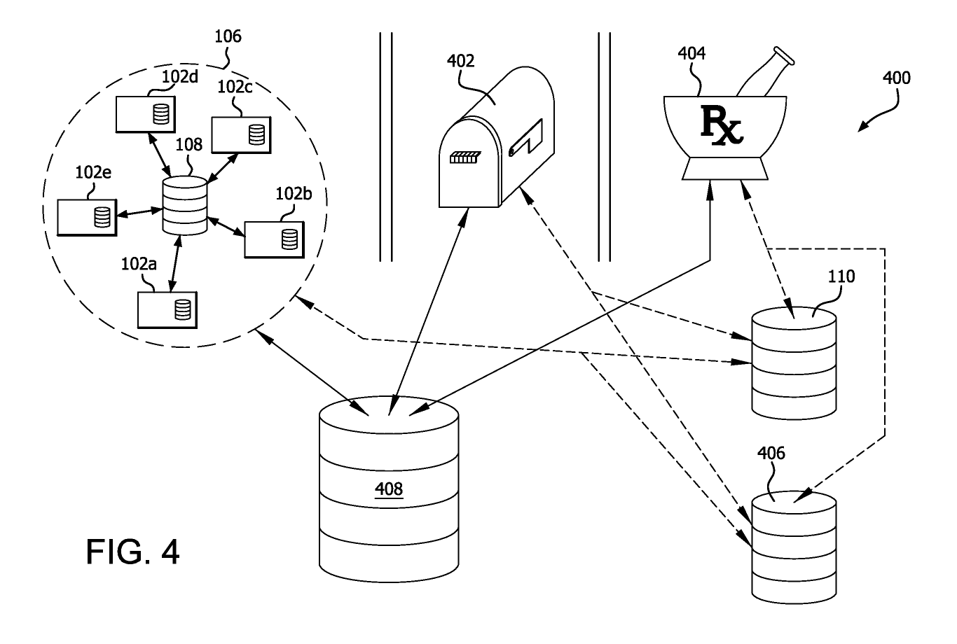

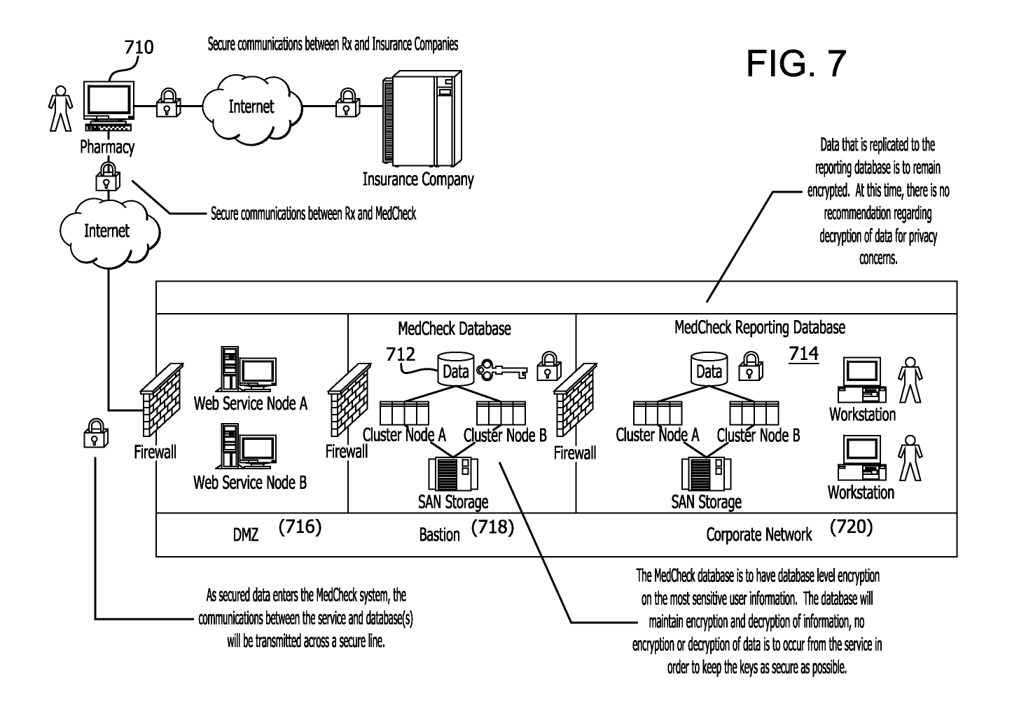

A system 400 according to an exemplary embodiment of the present invention will now be described in connection with FIG. 4. The system 400 includes retail pharmacy chain 106, which comprises individual retail pharmacies 102a-102e. The system 400 is also depicted as including a mail order pharmacy 402, and an independent pharmacy 404. It should be appreciated that the selection of pharmacy types is meant to be illustrative only, and any combination of pharmacies and pharmacy types could be included. The individual pharmacies of various pharmacy types still have access to a central insurance company database 110. A second insurance company database 406 is also shown, representing that multiple independent insurance companies can maintain separate central insurance company databases, which may be accessed by pharmacies. According to an embodiment of the present invention, a universal prescription database 408 is maintained that is accessible universally from any pharmacy, regardless of type, and regardless of whether a patient uses an insurance card or not. It should be understood that the dual direction arrows leading to and from the various pharmacies and insurance companies of FIG. 4 and the universal prescription database 408 indicate bi-directional communication capability via a communication interface (FIG. 7) of the universal prescription database. Preferably, the communication interface provides access to a wide area network with maximum availability, such as the Internet.

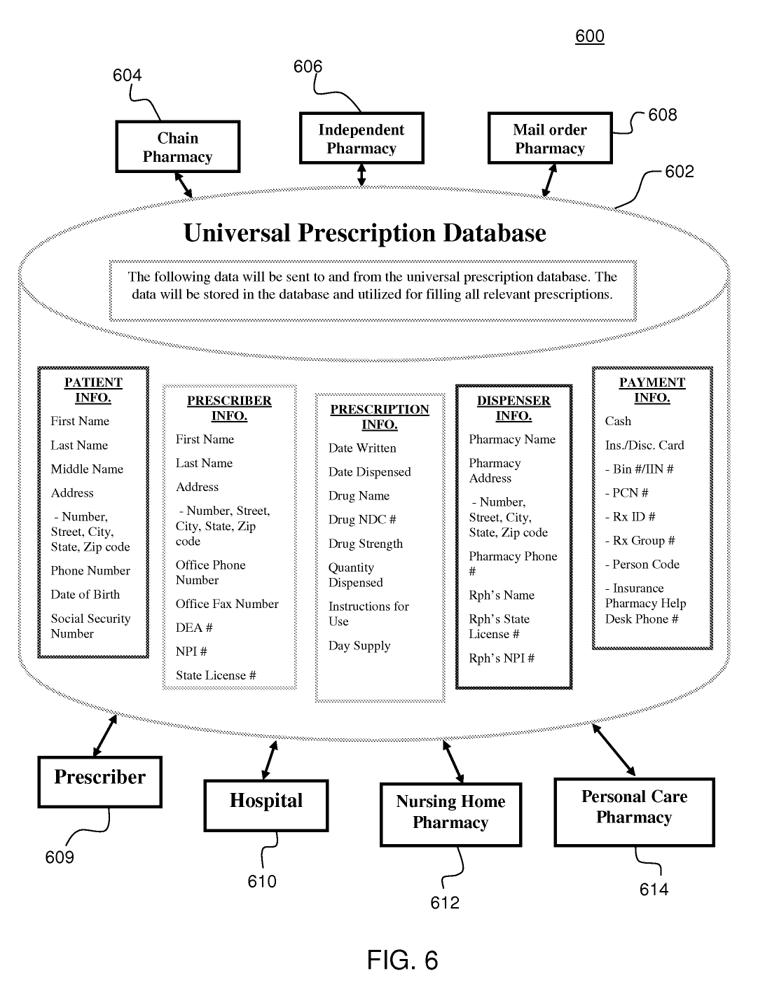

The universal prescription database 408 also includes a storage medium for storing various records (FIG. 6) as will be needed to perform the functions of the database. The records will preferably include patient records, with patient identification being achieved through unique patient identifiers, namely the patient's first name, last name, middle name, date of birth, and social security number. The records will also preferably include the patient's full address(s) and phone number(s). The records will also include prescription records. Each prescription record will preferably comprise the unique patient identifiers, a drug identifier (drug name and NDC number), strength, quantity, instructions for use, day supply, the date the prescription was written, and a prescription fill date. The prescription records will also preferably include the prescriber's name (first and last), prescriber's DEA number, prescriber's NPI number, prescriber's state license number(s), prescriber's full office address(es), office phone number(s) and office facsimile number(s). Prescription records will also preferably include the name of the pharmacy filling the prescription, the full address, phone number, pharmacist's full name, pharmacist's state license number, and pharmacist's NPI number. Finally, each prescription filled and dispensed will be saved for future comparison and will indicate how the prescription was paid. For example, if a patient uses a universal insurance card, the following information will be captured, saved, and transmitted for pharmacist knowledge: Insurance name, insurance Bank Identification Number (BIN #), Processor Control Number (PCN #), prescription identification number (RX ID #), prescription group number (RX Group #), person code and insurance pharmacy help desk phone number. Subsequently, if no insurance card was utilized (e.g. “CASH”), the transaction will record that as well. With each transaction sent to the system, an updated list of each patient's drug allergies and health condition will be stored in the systems database. Of course, those of ordinary skill in the art will readily appreciate that a wide variety of additional information may advantageously be recorded and stored in the database to provide additional functionality of the database.

The universal prescription database 408 of embodiments of the present invention provides several advantages over conventional systems and methods, as will be appreciated by those of ordinary skill in the art. The universal prescription database 408 preferably stores and transmits relevant prescription information for each individual prescription attempting to be filled, to and from pharmacies in order to provide pharmacists with a complete list of any potential problems that may exist. The universal prescription database according to an embodiment of the present invention preferably incorporates a series of identifiers, or markers, which will be used to classify all medications according to the specific class into which they are classified. These classifications may include, for example, beta-blockers, opiates, or other classifications known as drug class identifiers. Additionally, the universal prescription database according to an exemplary embodiment of the present invention preferably is programmed, and routinely updated, to include an extensive up-to-date list of drug interactions which will be used to determine if any interactions exist between any recently filled prescriptions and the prescription currently attempting to be filled. The interactions are preferably classified according to severity. In one embodiment the lowest severity interaction is classified “(1)” and the most severe interaction is classified “(5)”. Additionally, and preferably, an exemplary system uses the drug class identifiers to determine if any medications were filled recently, such as within the past 180 days, that would identify a potential problem.

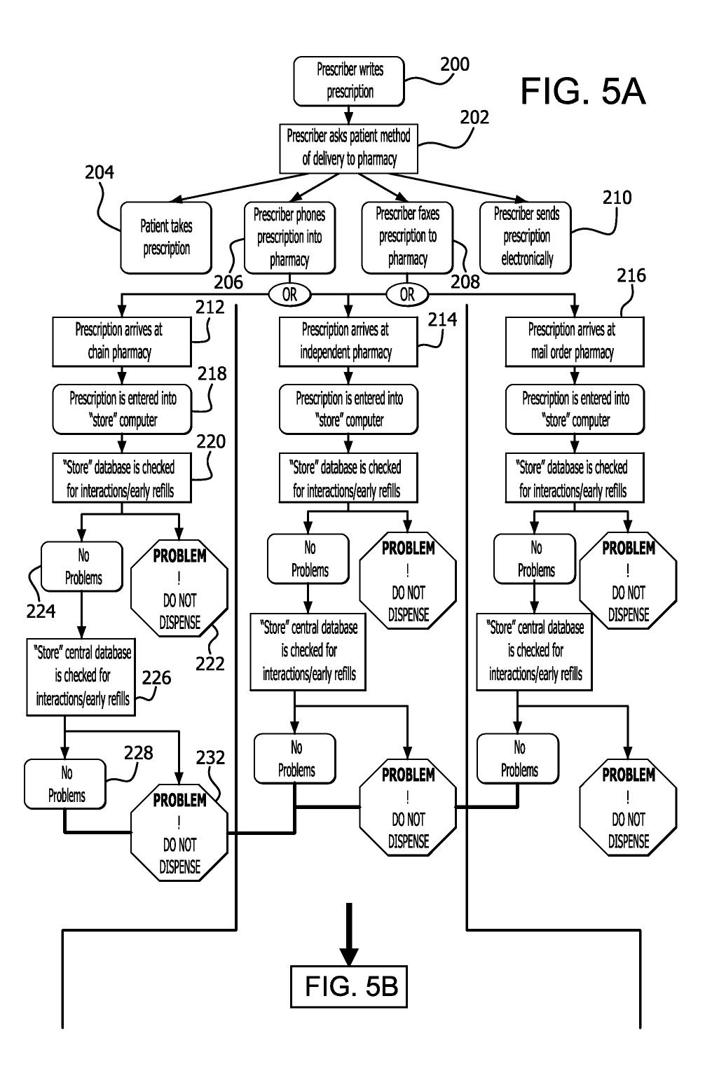

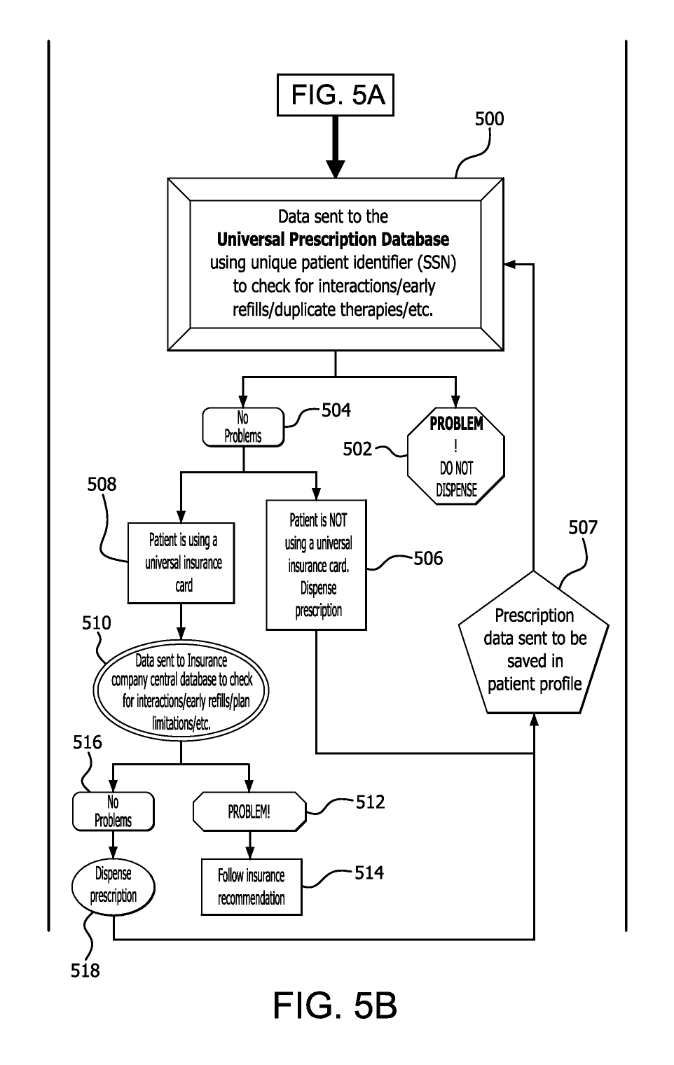

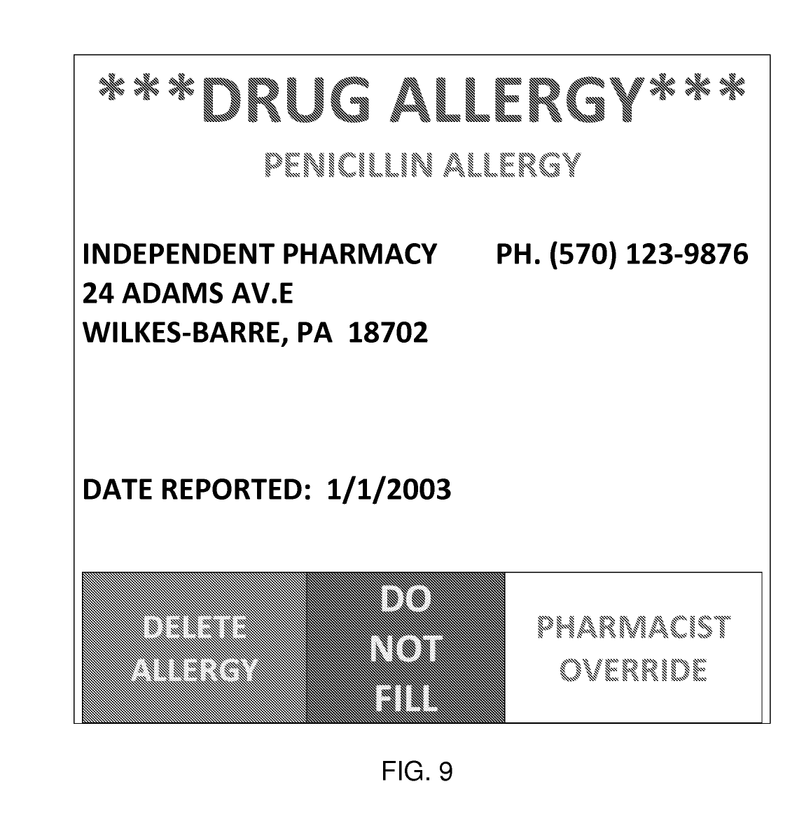

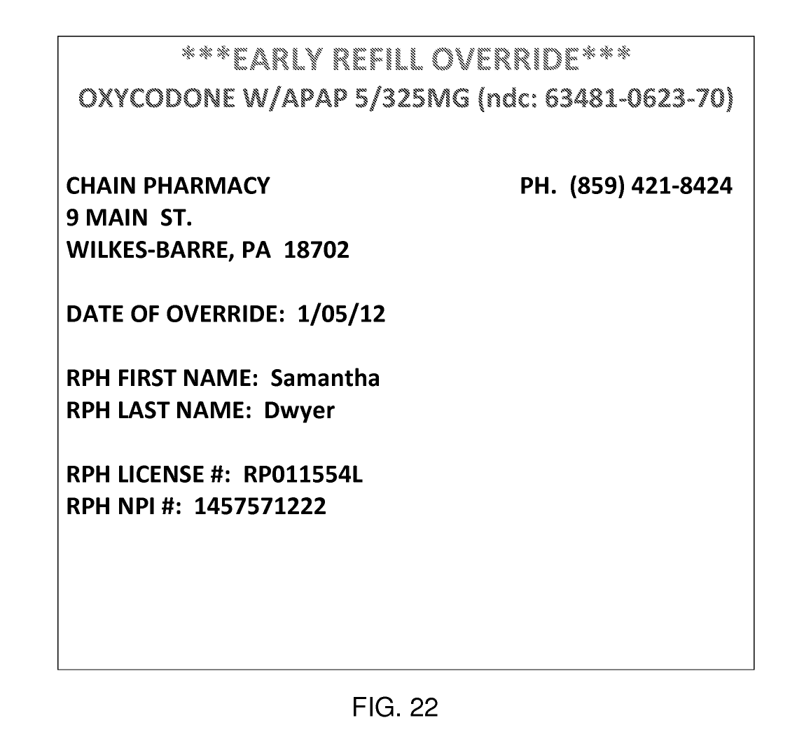

A method of filling a prescription according to an exemplary embodiment of the present invention will now be described in connection with FIGS. 5A and 5B. The first portion of the process, from a prescriber writing a prescription (step 200) through the pharmacy central database being checked (steps 226, 228, 232) are substantially the same as described in connection with FIG. 2, and so a detailed description thereof need not be repeated. If the check of the local database and the store's central database both return positive results, then according to exemplary embodiments of the present invention, the prescription information is then transmitted to the universal prescription database 408 at step 500. Preferably the data sent to the universal prescription database 408 includes the data identified in system 600 (FIG. 6). The universal prescription database receives and transmits data relevant to each prescription attempting to be filled at any pharmacy regardless of sector (retail, hospital, mail order, among others), and regardless of payment method, whether insurance card, cash payment, or otherwise. Accordingly, the universal prescription database advantageously has the most complete prescription history information available for each patient, regardless of which pharmacies, or how many pharmacies they have used, and regardless of the manner in which the patient pays for their prescriptions, past or present. If the universal prescription database 408 identifies a potential problem, that information is transmitted back to the pharmacist (See, for example, FIGS. 9, 12, 14, 15, 17, 18, 20, and 21), who can make a decision not to dispense, at step 502 (See also, FIG. 22). If the universal prescription database 408 does not identify any potential problems, than that status is transmitted to the pharmacist at step 504. At this point, the pharmacist has confidence that the prescription can be filled with a minimum chance of medication being dispensed improperly due to limited information available to the pharmacist.

Once the universal prescription database 408 has been utilized, if it is determined that the patient is not using a prescription insurance card, at step 506, the prescription can be dispensed and the prescription data is sent to the universal prescription database to be saved in the patient profile, at step 507. If the patient presents an insurance card at step 508, then a record of the prescription request can be transmitted to the insurance company central database 110 at step 510. The insurance company may still identify a problem, such as ineligibility for the particular medication under the patient's insurance coverage, among other potential problems, as will be understood by those of ordinary skill in the art. Accordingly, the insurance company database 110 may alert the pharmacist to a problem at step 512. The insurance company's recommendation may be followed at step 514. If the insurance company database 110 does not identify any problems at step 516, then the pharmacist may dispense the prescription at step 518. Preferably, the result of the pharmacist ultimately filling and dispensing a prescription is then transmitted to the universal prescription database 408 (step 507) so that the universal prescription database 408 has the most complete set of prescription history data available.

Of course it should be appreciated that the above described system and method are merely exemplary and various changes to the system and method described above may be made without departing from the scope and spirit of the invention. For example, a particular insurance company may determine that the universal prescription database 408 is superior and more cost effective than continuing to maintain their own separate database 110. Accordingly, particular insurance companies may solely utilize the universal prescription database 408. As such, the universal prescription database 408 could be programmed to analyze eligibility rules of the particular insurance company according to the insurance company's policies. Similarly, individual pharmacies and retail chains may eventually forego maintaining separate prescription databases in favor of the universal prescription database 408 described herein.

As will be understood, utilizing an exemplary system and/or method as described above, each time a prescription is written by a prescriber and filled at any pharmacy that utilizes a universal prescription database 408, an extensive search of all available prescription records will be performed to identify potential problems regardless of how many different prescribers and/or pharmacies the patient has used in the past. Advantageously, the results will include not only results of prescriptions filled utilizing any insurance card, but also of those prescriptions filled without a universal insurance card, including those not utilizing any type of insurance or discount card, referred to as “CASH” customers, discount cards, and so on. This information will then be sent back to the prescriber and/or pharmacist. The prescriber and pharmacist will then be able to evaluate the information and determine which course of action to take.

By running a universal prescription database 408 search for all prescriptions written, filled and dispensed, new prescriptions and refills, prescribers and pharmacists advantageously have access to substantially all relevant prescription information pertaining to the current prescription being filled, regardless of who prescribed the prescription, where other prescriptions were filled and dispensed, and whether a universal prescription insurance card was utilized or not. As a result, substantially all prescription information can pass through one universal prescription database 408, and all prescribers and pharmacists can utilize the universal prescription database 408 as if all pharmacies were part of one “chain” pharmacy. As shown in FIGS. 5A and 5B all prescriptions ultimately end up in one column, illustrating that all information has been transmitted to and stored in the universal prescription database 408 to be used for this, and all other relevant future prescriptions.

It will readily be appreciated by those of ordinary skill in the art that if the universal prescription database 408 described above were adopted by all prescribers and pharmacies, and if the universal prescription database were checked and updated for all prescriptions filled and refilled, the advantages and overall health improvements to society would be dramatic. Such a system and method would provide a simple, accurate, inexpensive method for prescribers and pharmacists to check for the same issues that are responsible for today's preventable medication errors. In addition, the system and method described herein provides a system with which to track prescribing trends for narcotics as well as narcotic abuse. Finally, the system and method described herein would preferably require every person to have a unique patient identifier in the universal prescription database 408 in order to have a prescription filled, or refilled. Such a system could be implemented on a national or international scale, such that the system could help to ensure that there is a patient record in the universal prescription database 408 for every person who fills a prescription. Moreover, those of ordinary skill in the art will readily appreciate that the system could be scaled up to be a global system.

A description of another exemplary embodiment of the present invention will now be described in connection with FIG. 6. The system 600 of FIG. 6 includes a universal prescription database 602 that is connected to a wide variety of pharmacies as well as being accessible by all licensed prescribers. As depicted, the pharmacies connected to the universal prescription database 602 include retail chain pharmacies 604, independent pharmacies 606, mail order pharmacies 608, hospitals 610, nursing homes 612, and personal care facilities 614. As shown, the universal prescription database may optionally be accessed by individual prescribers 609. Of course, those of ordinary skill in the art will readily appreciate that the particular pharmacy types depicted in FIG. 6 are merely exemplary, and intended to illustrate the wide variety of pharmacies which may participate in the universal prescription database 602. As shown, each pharmacy is capable of communicating with the universal prescription database 602 and exchanging information in both directions. New prescription records are transmitted to the universal prescription database 602. Preferably, for each relevant prescription, the following information preferably forms a prescription record that is transmitted to the universal prescription database 602 and utilized for future prescription checks: Patient data: First name, last name, middle name, full address, phone number(s), date of birth, social security number; Prescriber data: First name, last name, full office address, office phone number(s), office facsimile number(s), DEA #, NPI #, state license number(s); Prescription data: Date written, date dispensed, drug name, NDC #, drug strength, quantity dispensed, instructions for use, day supply; Dispenser data: Pharmacy name, full address, phone number, dispensing pharmacist's first name, dispensing pharmacist's last name, dispensing pharmacist's state license number(s), dispensing pharmacist's NPI #; Payment information: How the patient paid for the prescription (CASH, Insurance or discount card). If insurance or discount card—BIN #, PCN # RxID #, Rx Group #, Person code, Insurance's/discount card's pharmacy help desk phone number. In addition, it is advantageous for each record to be associated with a patient name and a unique patient identifier, such as a social security number. It should also be understood that licensed prescribers will also have access to the same information via an equally secure network to help in determining whether or not to prescribe a prescription(s).

FIG. 7. Illustrates how embodiments of the present invention will function at the pharmacy level. When a prescription is presented to a pharmacy 710 and entered into the pharmacy system prior to being filled and dispensed, the data is submitted to the universal prescription database server 712 on an encrypted Secure Sockets Layer (SSL) connection. Once entered into the service, the service will communicate to the universal prescription database on another encrypted SSL connection, which will preferably use a different certificate. Any data being returned to the client machine will be sent back across the same encrypted channels. The SSL connections will help safeguard the data as it is in transit from the client to the host. Any patient protected information (PPI) that is stored in the universal prescription database 712 is to be stored and encrypted as required by law. This data will not be decrypted to the reporting repository 714 unless absolutely necessary and will follow strict policies and procedures to ensure that this data, whatever it may be, is secured to avoid any sensitive data being released from the system. The overall composition of the network begins with a perimeter network 716, also known as a demilitarized zone (DMZ). This network is protected on both ends by firewalls. This network adds an additional layer of security to the organization's local area network (LAN), making it less vulnerable to attacks. Within the DMZ 716 is a sub-network identified as Bastion 718, also protected on both ends by firewalls. The Bastion 718 provides another line of defense in the event of a security breach. The final network, the Corporate Network 720, is utilized primarily for day to day system maintenance as well as reporting capabilities. Access to this data will be at a corporate level only and will have an added firewall for protection.

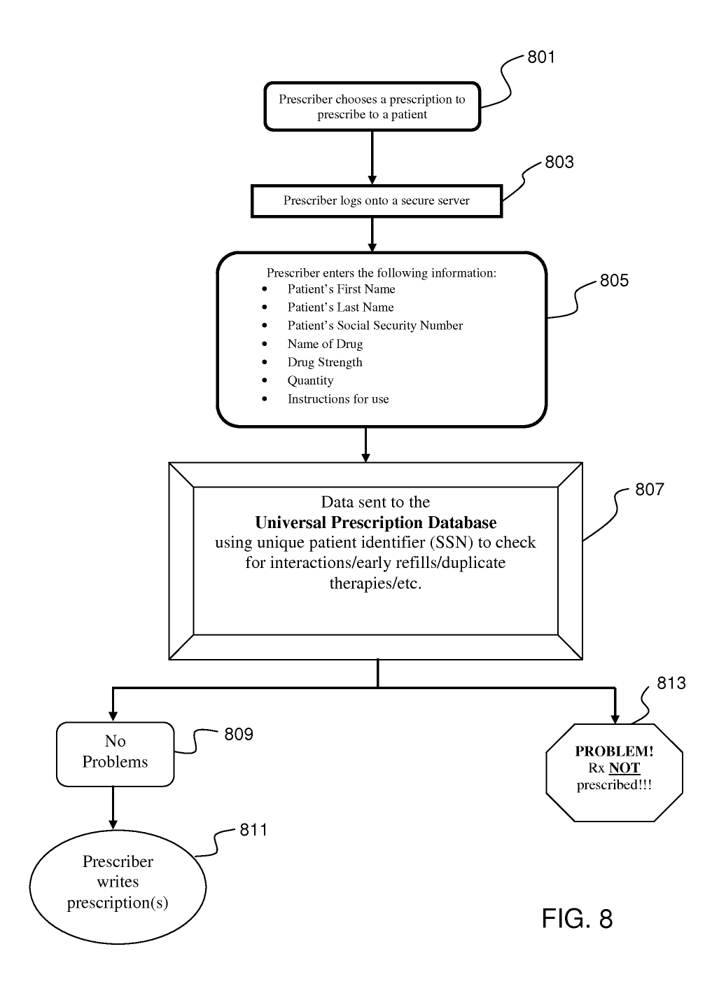

FIG. 8 illustrates the use of an embodiment of the present invention at the prescriber level. When a prescriber decides to write a prescription (step 801), the prescriber will have access to the most current, up-to-date data for their patient. By logging into a secure network (step 803), the prescriber could enter a patient's demographic data as well as the full prescription data for the desired prescription (step 805). Upon transmitting the claim to the universal prescription database across the secure network (step 807), a comprehensive check will be performed to check for drug allergies, negative drug-disease state interactions, negative drug-drug interactions, duplicate therapies, early refills (overuse of a medication), and other potential negative problems associated with all recent, relevant prescriptions dispensed to the patient. In real-time, a response will be transmitted back to the remote terminal informing the prescriber of any potential problems. If no problems are identified (step 809), then the prescriber may write a prescription at step 811. However, if a problem is identified, an alert is provided at step 813. It is important to note that this data will preferably NOT be stored in the universal prescription database. It will only be used for the prescriber to see what the patient already has had filled and by which prescriber(s). Only once the prescription is actually filled and dispensed will the data be updated in the centralized system and made available for future reference.

Examples of using an embodiment of the present invention to achieve a better outcome than is possible with conventional systems will now be provided.

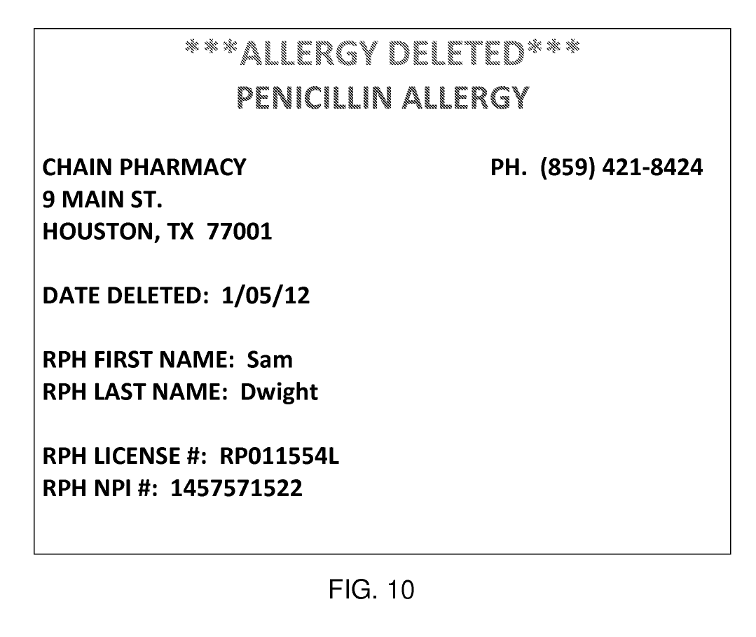

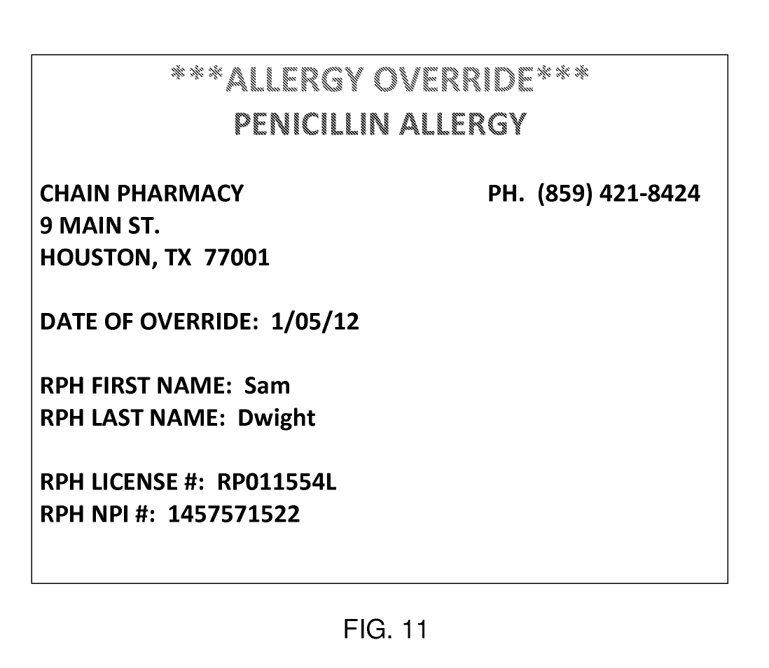

In a first example, a patient presents to the independent pharmacy (pharmacy 1) that he uses when he needs a prescription filled to inform his pharmacist that he has recently discovered that he has a drug allergy to Penicillin. The pharmacist updates his patient profile to indicate the newly identified drug allergy. Not long after, the patient is prescribed Azithromycin to treat a sore throat. During the filling process, this prescription data is transferred into the universal prescription database to check for any problems, such as drug allergies, negative drug-disease state interactions, negative drug-drug interactions, duplicate therapies, early refills (overuse of a medication), and other potential negative problems. The universal prescription database updates the patient's centralized profile to update the newly reported Penicillin allergy. Years pass and luckily the patient has not had a need for any prescriptions to be filled. During that time, however, the patient moved to a new state and was forced to find a new family care physician after coming down with an illness. During his first visit to the new physician, he fills out a new patient form. While filling out the form, he forgets to indicate the drug allergy to Penicillin that his previous physician identified years back. As the present physician was unaware of the allergy, he prescribes Penicillin to treat his condition. The patient then proceeds to a chain pharmacy (pharmacy 2) to have the prescription filled. As he has never used this particular pharmacy before, or any within the same chain, he takes a moment to provide his information to the pharmacist to enter in the computer system. Again forgetting his allergy to Penicillin, he neglects to inform the pharmacist of his drug allergy. The pharmacist proceeds to fill the prescription. After entering the prescription data into the pharmacy system, no problems are identified. Proceeding next to the step, the prescription data is then sent to the universal prescription database. After running a complete, detailed check an error is reported back to the pharmacist (FIG. 9) indicating that the patient has in the past reported an allergy to Penicillin. The result identified the date the allergy was reported as well as which pharmacy reported it. The pharmacist asks the patient about the reported allergy and confirmed that it was a true allergy. As a result, the pharmacist chose not to fill the prescription and called the prescribing physician for an alternative. Alternatively, FIG. 10 illustrates a screen that may be presented if the pharmacist determines that the allergy determination is in error. In that case, the pharmacist may be provided with an option to delete the indicated allergy. In another example, as shown in FIG. 11, the pharmacist may be provided with the option to override the allergy indication, and fill the prescription anyway. Preferably, identifying information of the pharmacist making the override decision is captured by the system, which is advantageous for auditing the system and accountability.

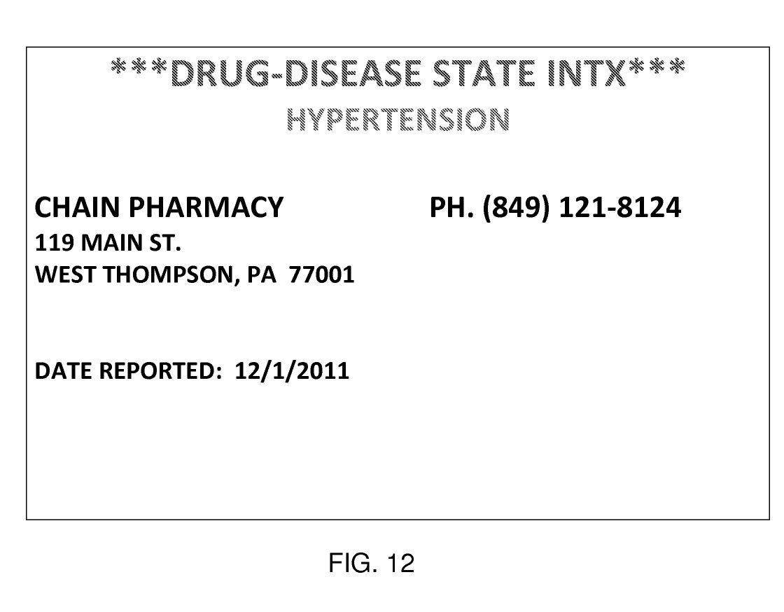

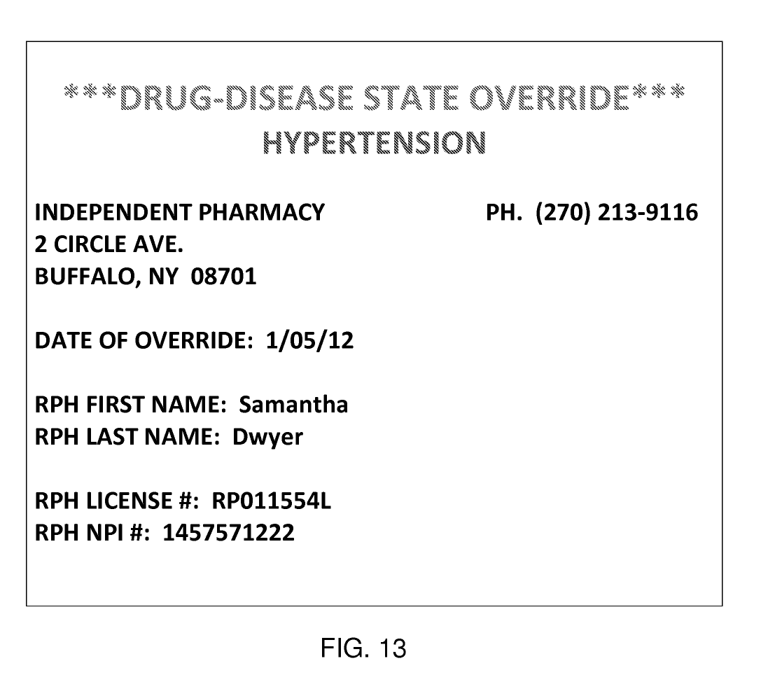

In a second example, a patient presents to a pharmacy for the first time. Upon registering as a new patient, he informs the pharmacist that the only medical condition that he is being treated for is hypertension (high blood pressure). He presents his prescription drug card, which was issued by the state department of welfare. This particular insurance card is only accepted in the state in which it was issued (in this case, Pennsylvania). He routinely gets his hypertensive medications filled at the same pharmacy. As a result, the universal prescription database has an up-to-date record of his drug allergies and health conditions. While on vacation in upstate New York, he begins to develop flu-like symptoms and decides to visit an urgent care facility. This facility has no record of this patient in their system. As a result, they must rely on the patient giving them an accurate, up-to-date medical history, including drug allergies and health conditions. Being in a hurry to get back to his hotel and rest, he forgets to inform the physician that he is being treated for hypertension. Prior to prescribing anything, the physician utilizes an in-house computer to transmit the prescriptions that he wishes to prescribe the patient to the universal prescription database. In real-time, the prescriber receives notification that the patient is currently taking a hypertensive medication (FIG. 12), which is a contraindication for the decongestant that he wanted to prescribe. The physician consults the patient, who immediately remembered that he forgot to tell the doctor of this. As a result, the physician was able to switch the medication to something safer. FIG. 13 Illustrates an exemplary screen presented by the system if a pharmacist overrides the contraindication once prescribed.

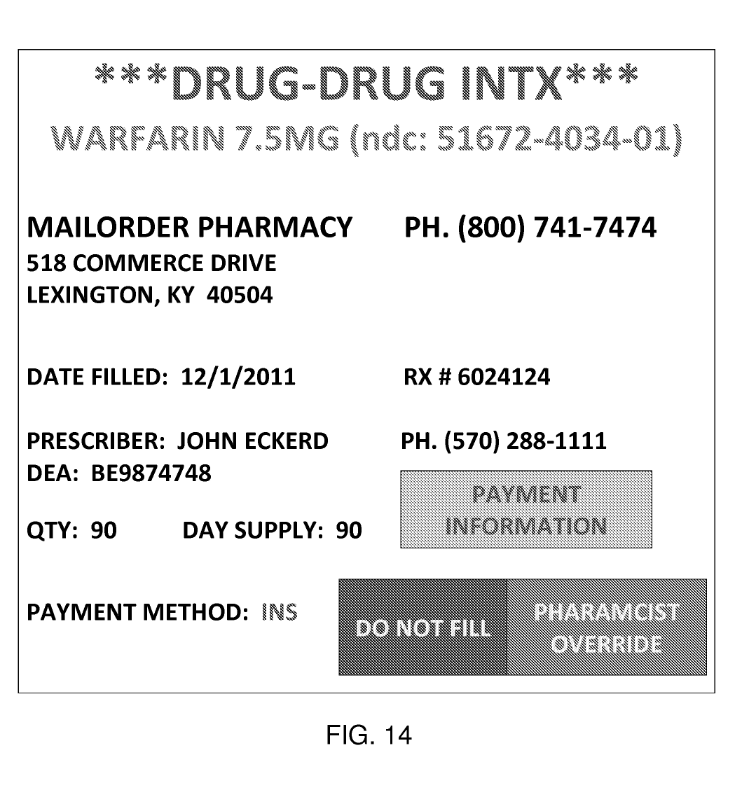

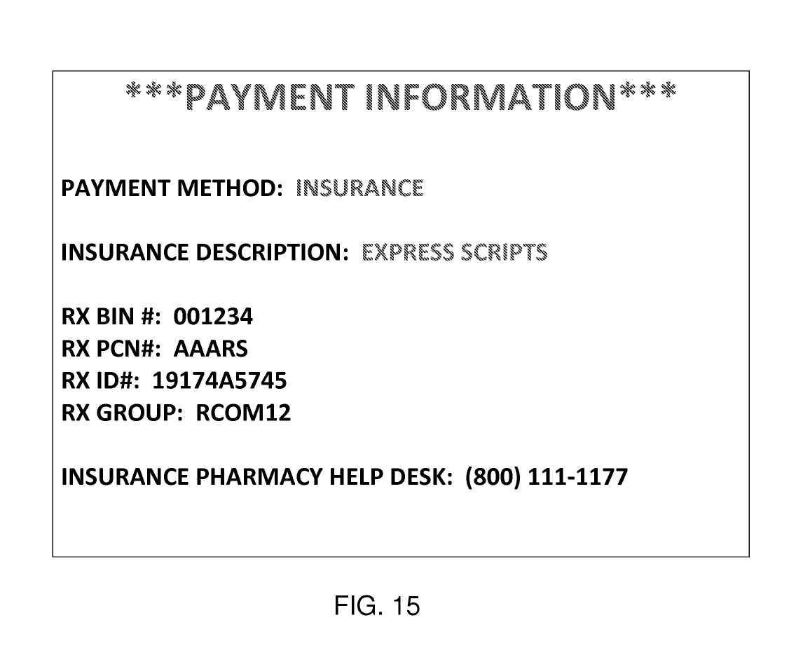

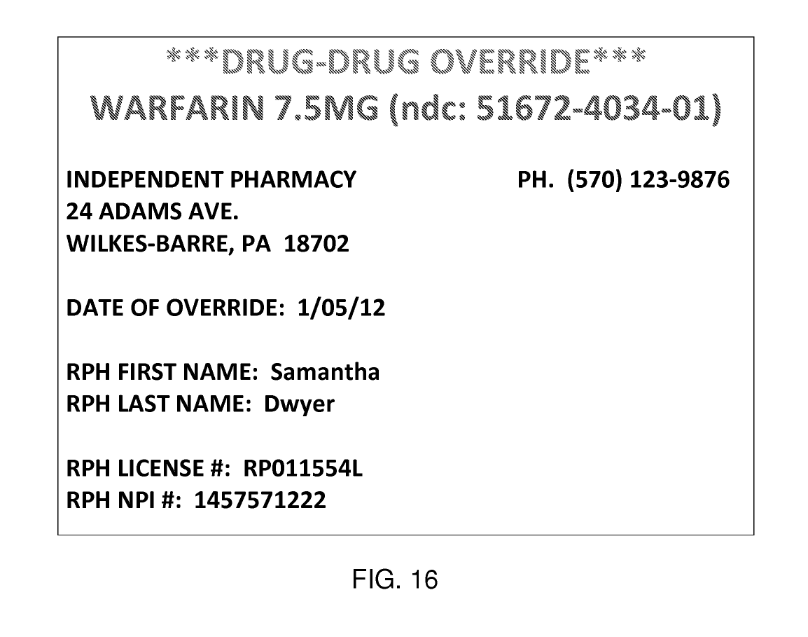

In a third example, an elderly man is living in a high rise housing complex. He is on a fixed income and is very cautious of what he spends. As a result, he gets a variety of maintenance prescriptions filled at 2 separate, unrelated pharmacies. He utilizes his prescription insurance card at one pharmacy (Pharmacy 1) to fill some prescriptions, and pays cash for other prescriptions at another pharmacy (Pharmacy 2). He utilizes the second pharmacy to take advantage of the $3 prescriptions they offer, which is cheaper than utilizing his prescription card. One day he presents to his primary physician's office complaining of a high fever and overall weakness. After a complete examination, the physician determines that the patient has a bacterial infection and prescribes the antibiotic Flagyl to treat it. He hands the prescription to the patient, who then proceeds to the pharmacy. Arriving at Pharmacy 2, the patient presents the prescription to the pharmacist. Upon entering the prescription data into the pharmacy computer system, the pharmacist runs a check on all of the current medications that the patient has filled at this pharmacy. As no problems are reported, the prescription is then sent to the universal prescription database for a more extensive check. Immediately, the pharmacist receives a message indicating a severe “DRUG-DRUG INTERACTION” (FIG. 14) with a prescription that the patient routinely has filled at Pharmacy 1, Warfarin. Immediately, the pharmacist informs the patient of the interaction, contacts the physician for an alternative medication and proceeds to safely fill the new antibiotic. FIG. 15 illustrates an exemplary screen generated by the system if the pharmacist chooses the “PAYMENT INFORMATION” option. FIG. 16 illustrates an exemplary screen generated by the system if the pharmacist overrides the drug-drug interaction warning.

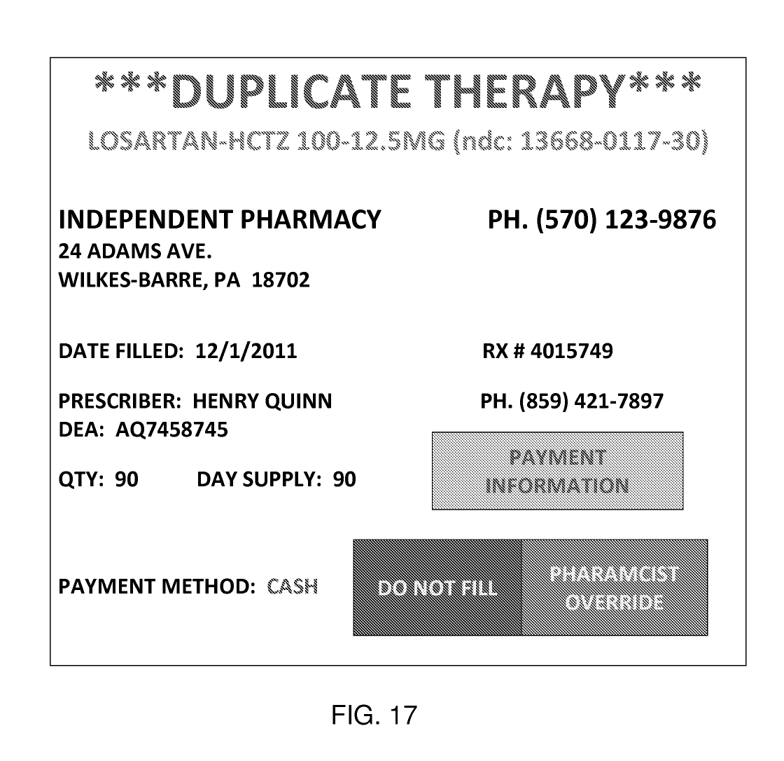

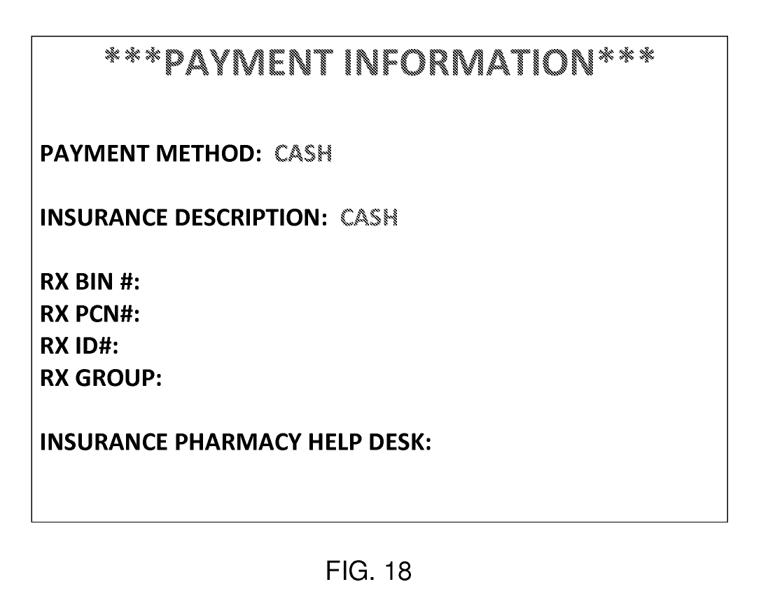

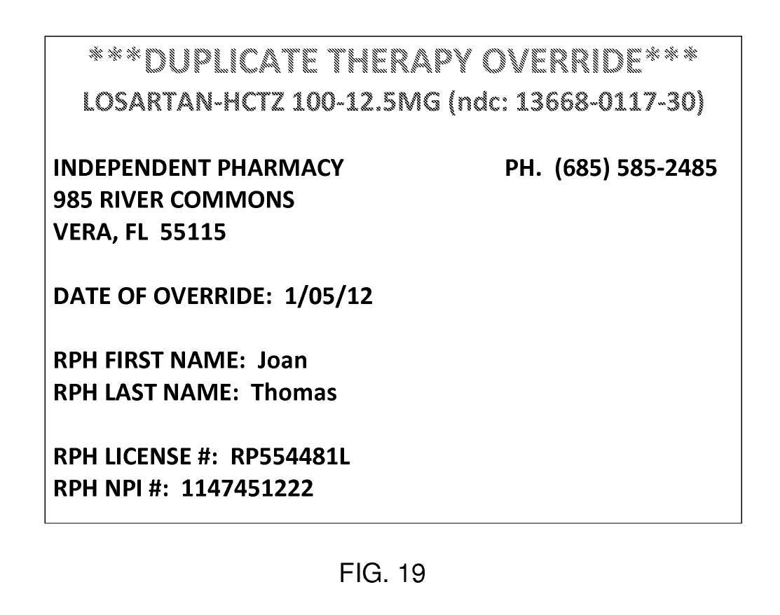

In a fourth example, an elderly woman arrives for a week-long visit to see her daughter, who lives a few states away. While packing for the trip, she places in an overnight bag all of her current medications. The list of these medications includes two medications to control her blood pressure (Hyzaar and Diovan), one medication to control her heart rate (Digoxin) and one medication to prevent blood clots (Warfarin). During her flight, she began experiencing slight chest pains and shortness of breath. So not to alarm anyone, she doesn't tell anyone until the plane lands. Upon landing, an ambulance takes her to the nearest hospital for evaluation. After a few hours, she is seen by an emergency room physician who looks over the list of medications that she provided to them. While she did remember to tell the physician that she was being treated with Hyzaar, Digoxin and Warfarin, she forgot to tell him of the Diovan. After completing all necessary tests, it was determined that the patient had experienced a panic attack. In addition, her blood pressure was a bit higher than desired. The ER physician decided to keep her on all of her current medications but to also add another anti-hypertensive medication to control her blood pressure better. She was advised to continue all previous medications as well as to fill and begin taking the new medication immediately. Upon leaving the hospital, she proceeds to the nearest pharmacy, a small independent store around the corner. She registers with the pharmacist and informs her that she does not have insurance. The pharmacist proceeds to process the new prescription. As soon as the pharmacist transmits the claim into the universal prescription database, a “DUPLICATE THERAPY” (FIG. 17) response is returned. The pharmacist recognizes that the patient was already on two anti-hypertensive medications. The pharmacist asks the patient if she notified the ER doctor of this and she said that she had not. The pharmacist calls the ER to speak with the prescribing doctor to inform him of this. As a result, the doctor told the pharmacist to cancel the prescription and inform the patient to simply continue taking the medications she was currently on. FIG. 18 illustrates an exemplary screen generated by the system if the pharmacist chooses the “PAYMENT INFORMATION” option. FIG. 19 illustrates exemplary data stored by the system if the pharmacist overrides the duplicate therapy warning.

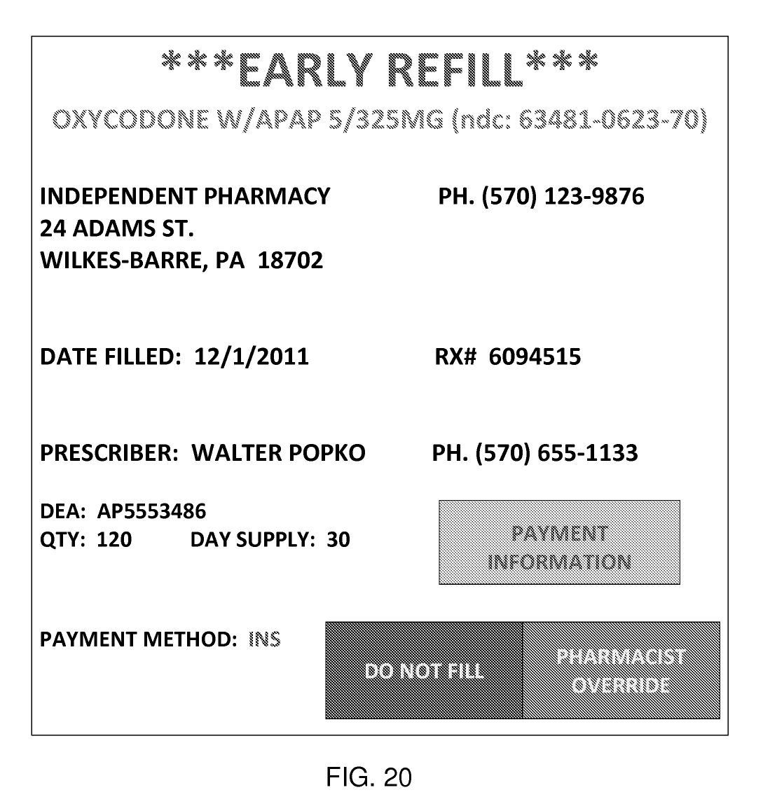

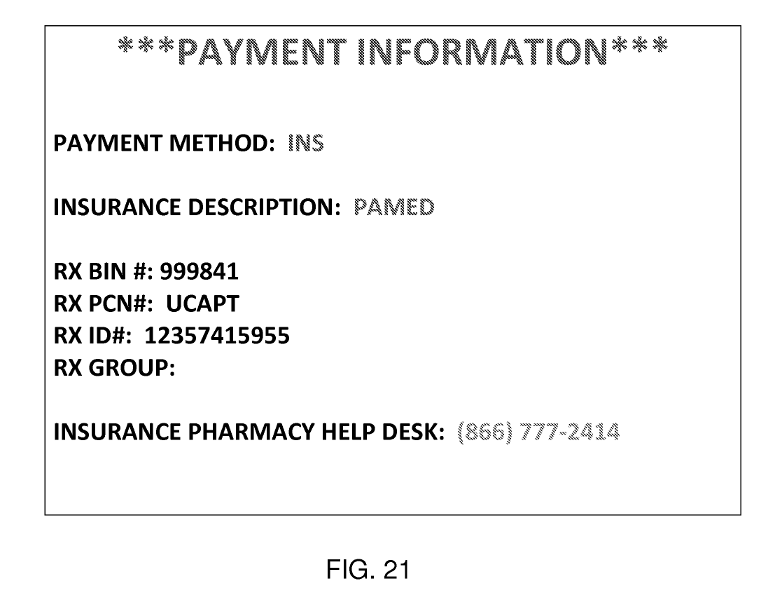

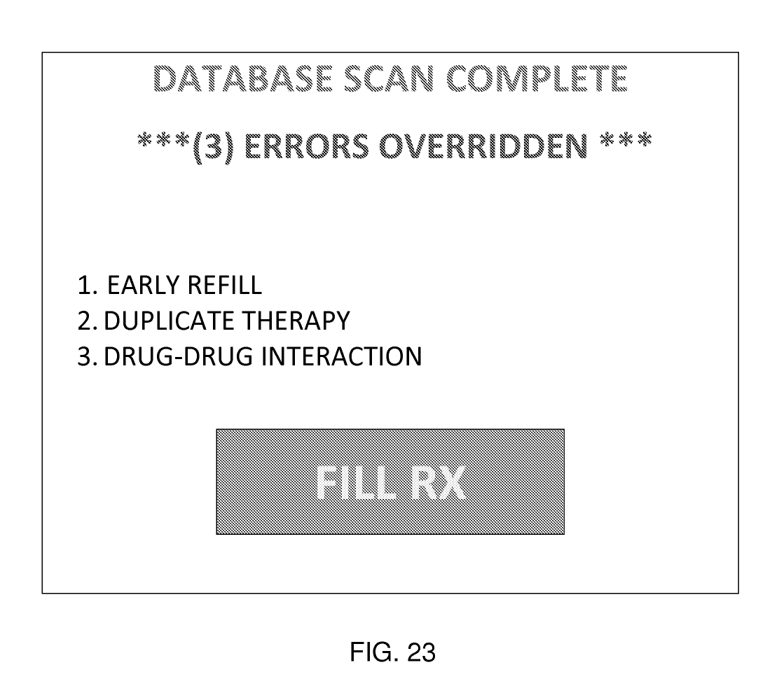

In a fifth example, a patient fills a prescription for Percocet 5/325 mg at an independent pharmacy (pharmacy 1). The prescription was written by Doctor “A” for a quantity of 120 tablets with instructions for use that would indicate that the prescription should last no less than 30 days. The patient utilizes a universally accepted insurance card and pays the designated copay. Three days later, the same patient makes an appointment to be seen by a second physician, Doctor “B”. When asked to complete a new patient questionnaire, he makes no reference to any other physician that he is seeing, particularly Doctor “A”. He proceeds to describe his aliments to Doctor “B” and indicates to Doctor “B” that he has seen the best relief from Percocet 5/325 mg. Doctor “B” in turn prescribes the patient Percocet 5/325 mg, a quantity of 120 tablets, to be take 1 tablet every 6 hours only as needed for pain. This prescription should last no less than 30 days. After leaving the office, the patient proceeds to a retail chain pharmacy (pharmacy 2). He presents the prescription to the pharmacist, registers as a new patient and indicates that he has no insurance. The pharmacist proceeds to enter the prescription into the pharmacy computer system. A series of checks is performed by the computer to check for drug allergies, negative drug-disease state interactions, negative drug-drug interactions, duplicate therapies, early refills (overuse of a medication), and other potential negative problems. Seeing as the patient had never had any prescriptions filled at this pharmacy or any other within the same chain, no errors are reported. After this initial check, the prescription record is then submitted to the universal prescription database. In real-time, the pharmacist receives an error report instantly indicating an “EARLY REFILL” (FIG. 20). The report showed that the same patient had the same prescription filled and dispensed three days earlier at an independent pharmacy. As part of the message received from universal prescription database, the pharmacist also was informed that the patient did in fact have insurance (FIG. 21). As a result, the pharmacist did not fill the prescription, called the prescribing physician to inform him of the other prescription recently filled, and destroyed the prescription per the physician's request. FIG. 21 illustrates an exemplary screen generated by the system if the pharmacist chooses the “PAYMENT INFORMATION” option. FIG. 22 illustrates exemplary data stored by the system if the pharmacist chooses to override the early refill warning. As with the previous examples, when a pharmacist overrides a warning, the pharmacist's identification information is preferably captured by the system to provide accountability. FIG. 23 illustrates an exemplary report generated by the system summarizing three errors that were overridden by the pharmacist.

In the sixth example, a local Drug Enforcement Agency (DEA) agent presents to a number of local pharmacy's inquiring about the prescribing habits of a local physician who has come under investigation for over-prescribing narcotics. After an extensive investigation, it was determined that an extraordinary number of prescriptions were prescribed by the physician over a period of two years. As part of the investigation, the DEA, through the appropriate legal steps, also requested records from the universal prescription database to support the over-prescribing habits. In the report, all data related to the dispensed prescriptions written by this physician were supplied. The report showed the following for each dispensed prescription: the date the prescription was written, the date the prescription was dispensed, the prescribing physician's full name, the prescribing physician's DEA number, the prescribing physician's NPI number, the prescribing physician's state license number(s), the prescribing physician's full office address, the prescribing physician's office phone and facsimile numbers, the name of the drug, the NDC of the drug, the drug strength, the quantity dispensed, and the day supply of the prescription. In addition, the report also showed for each dispensed prescription the name of the pharmacy that it was dispensed at, the full address of the pharmacy, the phone number of the pharmacy, the dispensing pharmacist's full name, and the dispensing pharmacist's NPI number and state license number. Finally, and most importantly, the report showed that for each prescription that was filled, the universal prescription database reported numerous errors that were reported back to the pharmacist for review. Each time the pharmacist overrode an error, the universal prescription database recorded the type of error(s), the name of the pharmacist who overrode the error(s), the overriding pharmacist's NPI number and state license number(s). Upon review of the report, it was identified that the majority of the prescriptions prescribed by the physician were filled at the same pharmacy and dispensed by the same pharmacist. By means of evaluating the recorded overrides of this specific pharmacist, it was determined that the prescriber and physician were working together.

In each of the above examples, it can be seen that the use of a universal prescription database advantageously provides prescribers and pharmacists with important information that they can use to achieve better outcomes for patients, including avoiding negative drug interactions, and preventing abuse of prescription drugs. In each of the examples, conventional systems are insufficient to provide the pharmacist with sufficient information to achieve these better outcomes. It will also be appreciated that the more prescribers and pharmacies that participate in the universal prescription database, the more effective it will be.

The below chart compares preferred features of an exemplary embodiment of the present invention to a conventional system and database maintained by, for example, an insurance company.

| | | Universal | |
|---|---|---|---|
| | | Prescription | Conven- |
| | | Database | tional |
| General Information | | System | Systems |
| 1. | Uses a centralized computer database | X | X |
| 2. | Database communicates centrally with all | X | |
| | pharmacies nationwide | | |
| 3. | Database could be utilized by pharmacists | X | X |
| 4. | Database requires a separate log in by | | |
| | pharmacist to utilize the database | | |
| 5. | Database could be accessed by prescribers | X | |
| 6. | Database requires a separate log-in by | X | |
| | prescriber to utilize the database | | |
| 7. | Database tracks ALL prescriptions filled | X | |
| | and dispensed | | |
| 8. | Database tracks filling history for ALL | X | |
| | medications for each individual | | |
| 9. | Database tracks prescribing habits of | X | |
| | prescriber for ALL medications | | |
| 10. | Database will securely store and transmit | X | |
| | ONLY relevant data with regard to ALL | | |
| | prescriptions attempting to be filled | | |
| 11. | Database will provide responses in real- | X | X |
| | time to remote terminals | | |
| 12. | Database has reporting capabilities | X | X |

| | | |
|---|---|---|
| | Universal | |
| | Prescription | Conven- |
| | Database | tional |
| Use of System | System | Systems |

| | |
|---|---|
| 1. | System could be utilized by: |

| | | |
|---|---|---|
| Pharmacists | X | X |
| Prescribers | X | X |
| Hospital Staff (other than prescribers) | | |
| Insurance Companies | X | X |
| Government Agencies | X | |

| | |
|---|---|
| 2. | Use of the system is initiated at the |
| | level of: |

| | | |
|---|---|---|
| Pharmacist | X | X |
| Prescriber | X | |

| | | | |
|---|---|---|---|
| 3. | Database will “communicate” with | X | |
| | prescriber/pharmacist by sending relevant | | |
| | information back to the remote location | | |
| | via secure messaging system | | |
| 4. | Database will store data immediately (in | X | X |
| | real-time) for immediate use by multiple | | |
| | remote locations | | |
| 5. | The decision to prescribe, fill and | X | |
| | dispense a prescription is based on the | | |
| | information sent back to the prescriber | | |
| | and pharmacist (at remote locations) from | | |
| | the universal database | | |

| | | |
|---|---|---|
| | Universal | |
| | Prescription | Conven- |
| | Database | tional |
| Information | System | Systems |

| | |
|---|---|
| 1. | Data required for the system to work: |

| | | |
|---|---|---|
| Patient's full name | X | X |
| Patient's date of birth | X | X |
| Patient's social security number | X | |
| Drug name | X | X |
| Drug strength | X | X |
| Drug quantity | X | X |
| Drug sig. (instructions for use) | X | X |
| Day supply of prescription | X | X |
| Prescriber's full name | X | X |
| Prescriber's DEA # | X | X |
| Prescriber's NPI # | X | X |
| Prescriber's state license # | X | X |
| Prescriber's office address | X | |
| Prescriber's office phone # | X | |

| | |
|---|---|
| 2. | After filling each prescription, both new and refills, |
| | the system will store: |

| | | |
|---|---|---|
| Patient's full name | X | X |
| Patient's full address | X | |
| Patient's phone # | X | |
| Patient's date of birth | X | X |
| Patient's social security number | X | |
| Prescriber's full name | X | X |
| Prescriber's full office address | X | |
| Prescriber's office phone # | X | |
| Prescriber's office facsimile # | X | |
| Prescriber's DEA # | X | X |
| Prescriber's NPI # | X | X |
| Prescriber's state license # | X | X |
| Date the prescription was written | X | X |
| Date the prescription was dispensed | X | X |
| Drug name | X | X |
| Drug NDC # | X | X |
| Drug strength | X | X |
| Drug quantity | X | X |
| Drug sig. (instructions for use) | X | X |
| Day supply of prescription | X | X |
| Pharmacy name | X | X |
| Pharmacy's full address | X | |
| Pharmacy's phone # | X | |
| Dispensing pharmacist's full name | X | |
| Dispensing pharmacist's state license # | X | |
| Dispensing pharmacist's NPI # | X | |
| Payment information | X | |
| If insurance used, the following is obtained: | | |

| | |
|---|---|
| 1. BIN # | X |
| 2. PCN # | X |
| 3. RxID # | X |
| 4. Rx Group # | X |
| 5. Person Code | X |
| 6. Insurance pharmacy help desk phone # | X |

| | |
|---|---|
| 3. | Each prescription run through the universal |
| | prescription database will return the following |
| | information relevant to each prescription |
| | attempting to be filled: |

| | | |
|---|---|---|
| Patient's full name | X | X |
| Patient's full address | X | |
| Patient's phone # | X | |
| Patient's date of birth | X | X |
| Patient's social security number | X | |
| Prescriber's full name | X | X |
| Prescriber's full office address | X | |
| Prescriber's office phone # | X | |
| Prescriber's office facsimile # | X | |
| Prescriber's DEA # | X | X |
| Prescriber's NPI # | X | X |
| Prescriber's state license # | X | X |
| Date the prescription was written | X | X |
| Date the prescription was dispensed | X | X |
| Drug name | X | X |
| Drug NDC # | X | X |
| Drug strength | X | X |
| Drug quantity | X | X |
| Drug sig. (instructions for use) | X | X |
| Day supply of prescription | X | X |
| Pharmacy name | X | X |
| Pharmacy's full address | X | |
| Pharmacy's phone # | X | |
| Filling pharmacist's full name | X | |
| Filling pharmacist's state license # | X | |
| Filling pharmacist's NPI # | X | |
| Payment information | X | |
| If insurance used, the following is obtained: | | |

| | |
|---|---|
| 1. BIN # | X |
| 2. PCN # | X |
| 3. RxID # | X |
| 4. Rx Group # | X |
| 5. Person Code | X |
| 6. Insurance pharmacy help desk phone # | X |

| | | |
|---|---|---|
| 4. | The universal prescription database will store all | X |
| | information for every prescription filled (new or | |
| | refill) by all persons regardless of whether or not | |
| | the person utilized a universally accepted | |
| | insurance card. | |
| 5. | Once verified through the universal prescription | X |
| | database, the database will then allow for claim | |
| | transmission to all insurance company computer | |
| | systems(if patient is utilizing an insurance card) to | |
| | verify the insurance company's | |
| | restrictions/limitations | |

| | | Universal | |
|---|---|---|---|
| | | Prescription | Conven- |
| | | Database | tional |
| Reporting Capabilities | | System | Systems |
| 1. | System tracks prescribing habit of prescriber for | X | |
| | ALL prescriptions written | | |
| 2. | Prescriber prescribing report includes: | | |

| | |
|---|---|
| Prescriber's full name | X |
| Prescriber's full office address | X |
| Prescriber's office phone # | X |
| Prescriber's office facsimile # | X |
| Prescriber's DEA # | X |
| Prescriber's NPI # | X |
| Prescriber's state license # | X |
| Patient's full name | X |
| Patient's full address | X |
| Patient's phone # | X |
| Patient's date of birth | X |
| Patient's social security number | X |
| Date the prescription was written | X |
| Date the prescription was dispensed | X |
| Drug name | X |
| Drug NDC # | X |
| Drug strength | X |
| Drug quantity | X |
| Drug sig. (instructions for use) | X |
| Day supply of prescription | X |
| Pharmacy name | X |
| Pharmacy's full address | X |
| Pharmacy's phone # | X |
| Filling pharmacist's full name | X |
| Filling pharmacist's state license # | X |
| Filling pharmacist's NPI # | X |
| Payment information | X |
| If insurance used, the following is obtained: | |

| | |
|---|---|
| 1. BIN # | X |
| 2. PCN # | X |
| 3. RxID # | X |
| 4. Rx Group # | X |
| 5. Person Code | X |
| 6. Insurance pharmacy help desk phone # | X |

| | |
|---|---|
| 2. | System tracks pharmacist over ride history for ALL |
| | prescriptions written |
| 3. | Pharmacist over ride report includes: |

| | |
|---|---|
| The type of override (e.g. early refill) | X |
| Filling pharmacist's full name | X |
| Filling pharmacist's state license # | X |
| Filling pharmacist's NPI # | |
| Prescriber's full name | X |
| Prescriber's full office address | X |
| Prescriber's office phone # | X |
| Prescriber's office facsimile # | X |
| Prescriber's DEA # | X |
| Prescriber's NPI # | X |
| Prescriber's state license # | X |
| Patient's full name | X |
| Patient's full address | X |
| Patient's phone # | X |
| Patient's date of birth | X |
| Patient's social security number | X |
| Date the prescription was written | X |
| Date the prescription was dispensed | X |
| Drug name | X |
| Drug NDC # | X |
| Drug strength | X |
| Drug quantity | X |
| Drug sig. (instructions for use) | X |
| Day supply of prescription | X |
| Pharmacy name | X |
| Pharmacy's full address | X |
| Pharmacy's phone # | X |
| Payment information | X |
| If insurance used, the following is obtained: | |

| | |
|---|---|
| 1. BIN # | X |
| 2. PCN # | X |
| 3. RxID # | X |
| 4. Rx Group # | X |
| 5. Person Code | X |
| 6. Insurance pharmacy help desk phone # | X |

| | |
|---|---|
| 3. | System tracks patient fill history of ALL |
| | medications dispensed |
| 4. | Patient fill history report includes: |

| | | |
|---|---|---|
| Patient's full name | X | X |
| Patient's full address | X | |
| Patient's phone # | X | |
| Patient's date of birth | X | X |
| Patient's social security number | X | |
| Prescriber's full name | X | X |
| Prescriber's full office address | X | |
| Prescriber's office phone # | X | |
| Prescriber's office facsimile # | X | |
| Prescriber's DEA # | X | X |
| Prescriber's NPI # | X | X |
| Prescriber's state license # | X | X |
| Date the prescription was written | X | X |
| Date the prescription was dispensed | X | X |
| Drug name | X | X |
| Drug NDC # | X | X |
| Drug strength | X | X |
| Drug quantity | X | X |
| Drug sig. (instructions for use) | X | X |
| Day supply of prescription | X | X |
| Pharmacy name | X | X |
| Pharmacy's full address | X | |
| Pharmacy's phone # | X | |
| Filling pharmacist's full name | X | |
| Filling pharmacist's state license # | X | |
| Filling pharmacist's NPI # | X | |
| Payment information | X | |
| If insurance used, the following is obtained: | | |

| | |
|---|---|
| 1. BIN # | X |
| 2. PCN # | X |
| 3. RxID # | X |
| 4. Rx Group # | X |
| 5. Person Code | X |
| 6. Insurance pharmacy help desk phone # | X |

While the invention has been shown and described with reference to certain embodiments thereof, it will be understood by those skilled in the art that various changes in form and details may be made therein without departing from the spirit and scope of the invention as defined by the appended claims.

What is claimed is:

1. A universal prescription database comprising:
a storage medium storing a plurality of patient records and prescription records, the patient records each comprising at least a unique patient identifier, and the prescription records each comprising at least a patient identifier, a drug identifier, a strength, a quantity, and a prescription fill date;
a communications interface for receiving database requests from remote terminals, and for sending database responses to remote terminals;
wherein the universal prescription database is programmed to receive a database request via the communications interface, the database request comprising at least a new prescription record, to compare the new prescription record with existing prescription records associated with the same unique patient identifier, and to send a response to remote terminals via the communications interface;
wherein the response is based on the comparison of the new prescription record with existing prescription records associated with the same unique patient identifier.

2. The universal prescription database of claim 1, wherein the storage medium further stores prescriber records, pharmacy records, and dispenser's records,
wherein the unique patient identifier comprises patient first name, patient last name, patient date of birth, and patient social security number,
wherein prescription records comprise National Drug Code number (NDC#), drug strength, dispense quantity, day supply, instructions for use, and prescription written date;
wherein the prescription records comprise prescriber identifiers, the prescriber identifiers comprising prescriber's first name, prescriber's last name, prescriber's DEA number, prescriber's NPI number, prescriber's state license number(s), prescriber's office phone number, prescriber's address, and prescriber's facsimile number; and
wherein the prescription records further comprise dispenser identifiers, the dispenser identifiers comprising pharmacy name, pharmacy number, pharmacy address, pharmacy phone number, pharmacy facsimile number, dispensing pharmacist first name, dispensing pharmacist last name, dispensing pharmacist state license number, and dispensing pharmacist NPI number.

3. The universal prescription database of claim 1, wherein the communications interface is a secure communications interface.

4. The universal prescription database of claim 1, wherein the comparison identifies one or more conditions selected from the group consisting of drug allergies, negative drug-disease state interactions, negative drug-drug interactions, duplicate therapies, early refills, overuse of a medication, and other potential negative problems.

5. The universal prescription database of claim 4, wherein potential negative drug-disease state or drug-drug interactions are assigned a rating according to severity and the rating is included in the response.

6. The universal prescription database of claim 1, wherein the response comprises a pharmacist override or do not fill determination.

7. The universal prescription database of claim 1, wherein the database is updated with a new prescription record based on the database request received via the communications interface.

8. The universal prescription database of claim 1, wherein the prescription records further comprise an insurance company identifier, and wherein a first prescription record associated with a first patient comprises an insurance company identifier for a first insurance company, and a second prescription record associated with a first patient comprises an insurance company identifier for a second insurance company.

9. The universal prescription database of claim 1, wherein the prescription records further comprise an insurance field that identifies whether an insurance claim is associated with the prescription record.

10. The universal prescription database of claim 9, wherein if the insurance field does not indicate that an insurance claim is associated with the prescription record, the insurance filed indicates that the prescription was paid for with cash.

11. A method of filling a prescription using a universal prescription database, the method comprising the steps of:
storing a plurality of patient records and prescription records in a storage medium of the universal prescription database, the patient records each comprising at least a unique patient identifier, and the prescription records each comprising at least a patient identifier, a drug identifier, a strength, a quantity, and a prescription fill date;
receiving a database request from remote terminals via a communications interface of the universal prescription database, wherein the database request comprises at least a new prescription record;
comparing the new prescription record with existing prescription records associated with the same unique patient identifier;
preparing a response based on the comparison of the new prescription record with existing prescription records associated with the same unique patient identifier; and
sending the response to remote terminals via the communications interface.

12. The method of claim 11, further comprising the steps of storing prescriber records, pharmacy records, and dispenser's records in the storage medium;
wherein the unique patient identifier comprises patient first name, patient last name, patient date of birth, and patient social security number;
wherein prescription records comprise National Drug Code number (NDC#), drug strength, dispense quantity, day supply, instructions for use, and prescription written date;
wherein the prescription records comprise prescriber identifiers, the prescriber identifiers comprising prescriber's first name, prescriber's last name, prescriber's DEA number, prescriber's NPI number, prescriber's state license number(s), prescriber's office phone number, prescriber's address, and prescriber's facsimile number; and
wherein the prescription records further comprise dispenser identifiers, the dispenser identifiers comprising pharmacy name, pharmacy number, pharmacy address, pharmacy phone number, pharmacy facsimile number, dispensing pharmacist first name, dispensing pharmacist last name, dispensing pharmacist state license number, and dispensing pharmacist NPI number.

13. The method of claim 11, wherein the communications interface is a secure communications interface.

14. The method of claim 11, wherein the comparing step further comprises identifying one or more conditions selected from the group consisting of drug allergies, negative drug-disease state interactions, negative drug-drug interactions, duplicate therapies, early refills, overuse of a medication, and other potential negative problems.

15. The method of claim 14, wherein negative drug-drug interactions are assigned a rating according to severity and the rating is included in the response.

16. The method of claim 14, wherein the comparing step further comprises identifying potential drug-disease state interactions.

17. The method of claim 16, wherein the potential drug-disease state interactions are assigned a rating according to severity and the rating is included in the response.

18. The method of claim 11, wherein the step of preparing the response further comprises including a pharmacist override or do not fill determination in the response.

19. The method of claim 11, further comprising the step of updating the universal prescription database with a new prescription record based on the database request received via the communications interface.

20. The method of claim 11, wherein the prescription records further comprise an insurance company identifier, and wherein a first prescription record associated with a first patient comprises an insurance company identifier for a first insurance company, and a second prescription record associated with a first patient comprises an insurance company identifier for a second insurance company.

21. The method of claim 11, wherein the prescription records further comprise an insurance field that identifies whether an insurance claim is associated with the prescription record.

22. The method of claim 21, wherein if the insurance field does not indicate that an insurance claim is associated with the prescription record, the insurance filed indicates that the prescription was paid for with cash.
